(19) United States
(12) Patent Application Publication
(10) Pub. No.: US 2026/0344615 A1
(43) Pub. Date: Nov. 5, 2026

(54) ANIMAL CONTAINMENT SYSTEM

(71) Applicant: Jani International Pte. Ltd.

(72) Inventors: Curtis M. HARTENSTINE, Birdsboro, PA (US); Lance J. CLEMMER, Mohnton, PA (US); Joshua FERGUSON, Southampton, PA (US); Colin F. EGGERT-CROWE, King of Prussia, PA (US); Patrick JG BOWERS, West Chester, PA (US)

(73) Assignee: Jani International Pte. Ltd., (omitted)

(21) Appl. No.: 19/478,426

(22) PCT Filed: Apr. 25, 2024
(86) PCT No.: PCT/US2024/026243

§ 371 Date: Oct. 24, 2025

Related U.S. Application Data
(60) Provisional application No. 63/498,419, filed on Apr. 26, 2023.
(60) Provisional application No. 63/512,448, filed on Jul. 7, 2023.
(60) Provisional application No. 63/512,670, filed on Jul. 10, 2023.
(60) Provisional application No. 63/520,282, filed on Aug. 17, 2023.
(60) Provisional application No. 63/591,640, filed on Oct. 19, 2023.
(60) Provisional application No. 63/607,371, filed on Dec. 7, 2023.
(60) Provisional application No. 63/607,375, filed on Dec. 7, 2023.
(60) Provisional application No. 63/631,007, filed on Apr. 8, 2024.

(51) Int. Cl. A01K 1/02; B60P 3/04; B60R 11/00

(52) U.S. Cl. CPC A01K 1/0272; B60P 3/04; B60R 11/00; B60R 2011/0071

(57) ABSTRACT

An assembly includes a docking station or other impact protection component and an animal containment unit. The station is configured to secure the assembly to a vehicle. The station includes a base including rigid support members or tensionable flexible members extendable from anchor points in the base to anchor points in the vehicle so that the station is installed within the vehicle. The unit includes one or more features configured to attach the unit to the station so that the unit is secured within the vehicle and detaching the unit from the station so that the unit is removed from the vehicle when the station is installed in the vehicle.

### CROSS REFERENCE TO RELATED APPLICATION

This application claims the benefit of U.S. Provisional Patent Application Nos. 63/498,419, filed on Apr. 26, 2023; 63/512,448, filed on Jul. 7, 2023; 63/512,670, filed on Jul. 10, 2023; 63/520,282, filed on Aug. 17, 2023; 63/591,640, filed on Oct. 19, 2023; 63/607,371, filed on Dec. 7, 2023; 63/607,375, filed on Dec. 7, 2023; and 63/631,007, filed on Apr. 8, 2024, which are incorporated by reference as if fully set forth.

### TECHNICAL FIELD

The present disclosure relates generally to a pet containment system. In particular, the present disclosure relates to a pet containment system for securing a pet or an animal in a vehicle.

### BACKGROUND

Many people regard their pets as family members or companions. As such, pet owners often travel with their pets via automobile to vacation destinations, trips to the veterinarian, or around town. Pet transport devices are available that cooperate with safety belts or other anchor points of a vehicle to prevent a pet from roaming within and/or escaping from a vehicle. However, these devices generally do not adequately secure a pet in the case of a sudden change in vehicle speed or direction, and can be difficult to install in a vehicle. An improperly restrained pet is more likely to be injured and to injure occupants of a vehicle during a crash.

Some dog crates lack safety features and the ability to securely attach them to a vehicle. Additionally, dog crates that do attach to the vehicle often take up considerable room in the cargo area when not in use. These dog crates can also be difficult to install and remove.

### SUMMARY

Aspects of the present disclosure are directed to an animal containment system for containing an animal in a vehicle. The system can comprise a docking station configured to be received in a cargo area of a vehicle, and an animal containment unit selectively mountable to the docking station.

The docking station can include at least one anchor point for securing the docking station to at least one anchor point of the vehicle. The animal containment unit can include at least one rigid support structure for engaging a non-horizontal surface of the vehicle, the at least one rigid support structure configured to restrict relative movement of the docking station or the animal containment unit relative to the non-horizontal surface. The docking station can include a plurality of rigid support structures, each rigid support structure adapted to engage a different non-horizontal surface of the vehicle. At least two of the plurality of rigid support structures can extend from opposite sides of the docking station. At least one rigid support structure can be movable between a stowed position and a deployed position. The at least one rigid support structure can be adjustable in length. The docking station can include a latch configured to selectively secure the animal containment unit to the docking station. The animal containment unit further can include a rotatable and extendable handle. The handle can be rotatable to a horizontal orientation and extendable to engage a non-horizontal surface of the vehicle to secure the animal containment unit when the animal containment unit is attached to the docking station. The docking station can include a base having brackets fixed to side surfaces of the base, the brackets comprising the at least one anchor point and further including tensionable flexible members extending from the brackets for attachment to the at least one anchor point of the vehicle. The tensionable flexible members can include tethers. The docking station can include a ramp extending from a rear portion of the base. The ramp can be telescoping and can include extensions storable within a cavity in the base. The docking station can include a base, and the at least one rigid support structure can be U-shaped including first members slidable within side surfaces of the base so that the first members can be slid into a cavity in the base or slid out from the cavity to adjust a length of the at least one rigid support structure. The rigid support structure can include a second member configured to engage an interior surface of the vehicle. The docking station can include a base, and the docking station can further include a vertical rigid support member having first members extending from side surfaces of the base and curving vertically and a second member including sliding members slidable within the first members to adjust a length of the vertical rigid support member. The animal containment unit can include wheels on a bottom surface. The docking station can include two spaced-apart rails adapted to support the animal containment unit. Each rail can include a protrusion adapted to be received in a corresponding recess of the animal containment unit to secure the animal containment unit to the docking station. The protrusion can include an L bracket, and the corresponding recess can include a slot. Each rail can include an end face having at least one of a recess or protrusion and the animal containment unit can include a corresponding mating recess or protrusion adapted to secure the animal containment unit to the docking station. The docking station can include a load leg configured to engage a seatback of a vehicle. The load leg can include an adjustable engagement member, the adjustable engagement member being adjustable to match an angle of the seatback of a vehicle. The adjustable engagement member can be biased towards a vertical orientation. The system can further include an organizer mountable to the docking station.

In accordance with another aspect, an animal containment unit comprises a containment body defining an interior space sized to receive an animal, the containment body comprising a base securable to a vehicle, the base having anchor points and members extendable from the anchor points to further anchor points of the vehicle so that the unit is securable to the vehicle and detachable from the vehicle. The members include rigid support members or tensionable flexible members. The containment body can be permanently mounted to the base.

In accordance with another aspect, an animal containment unit comprises a containment body defining an interior space sized to receive an animal, the containment body comprising, anchor points, and members extendable from the anchor points, the members being configured to attach to further anchor points of a vehicle so that the unit is securable to the vehicle and detachable from the vehicle. The members include rigid support members or tensionable flexible members.

In accordance with another aspect, an animal containment system for installation in a cargo area of a vehicle comprises a docking station having: a front load leg configured to engage a seatback of a vehicle, and a first mounting structure, and a containment unit having a front wall, sidewalls, a rear door opposite the front wall, and a second mounting structure. The first mounting structure and the second mounting structure are configured to interfit together when the containment unit is installed on the docking station with the front wall oriented toward the front load leg, and the front wall is structurally reinforced relative to the sidewalls.

The docking station can comprise a frame having side rails and crossbars. The side rails can telescope. The telescoping side rails can have retaining structure configured to hold an extended configuration after installation. The side rails can include a guide structure and containment device comprises a complementary-shaped bottom portion. The guide structure can include one or more rollers. The docking station can include an actuator to extend the front load leg forward. The front load leg can include a planar panel. The front load leg can be angularly adjustable, and configured to conform to an angle of a vehicle seatback. Angular adjustment of the front load leg can be biased toward a vertical orientation. The docking station can include at least one side load leg. The first mounting structure can include a slot and the second mounting structure comprises a tab adapted to be received in the slot. The first mounting structure can include a protrusion and the second mounting structure can include a recess. The containment unit front wall can include a high-tensile strength component. The high-tensile strength component can include at least one of a steel cable, sheet metal, or heavy-duty Nylon webbing. The high-tensile strength component can be embedded within the front wall.

In accordance with another aspect, a docking station for installation in a rear cargo area of a vehicle comprises a base including a frame, and a front load leg coupled to the frame and configured to engage a seatback of a vehicle. The frame can include side rails and crossbars. The side rails can telescope. The telescoping side rails can include retaining structure configured to hold an extended configuration after installation. The side rails can include a guide structure. The guide structure can include one or more rollers. The docking station can include an actuator to extend the front load leg forward. The front load leg can include a planar panel. The front load leg can be angularly adjustable and configured to conform to an angle of the seatback. Angular adjustment of front load leg can be biased toward a vertical orientation. The docking station can further include at least one side load leg.

In accordance with another aspect, an animal containment system for installation in a cargo area of a vehicle comprises an animal containment unit configured to contain an animal within, and an impact protection component connected to the animal containment unit, the impact protection component being at least partially positionable between a seat back portion of the vehicle and the animal containment unit when the animal containment system is installed in the cargo area such that when a first force is applied to the impact protection component by the animal containment unit a second force is applied to the impact protection component by the seat back portion.

The impact protection component can extend along a length of the animal containment unit. The impact protection component can be movable relative to the animal containment unit. The impact protection component can be rotatable relative to the animal containment unit. The impact protection component can include a contact surface positioned to align with a surface of the seat back portion, and an angle of the contact surface can be adjustable by movement of the impact protection component relative to the animal containment unit. The impact protection component can be configured to absorb at least one of the first force and the second force such that a shape of the impact protection component is distorted when the first force and the second force are applied to the impact protection component. The impact protection component can be removably connected to the animal containment unit. A height of the impact protection component can be at least a quarter of a height of the animal containment unit when the animal containment system is installed in the cargo area. The impact protection component can include a storage compartment. The impact protection component can include a coupling bar, and wherein the animal containment unit includes a latch adapted to releasably engage the coupling bar. The impact protection component can include a load leg configured to engage a seatback of the vehicle. The load leg can be adjustable to change an angle of a contact surface of the load leg. The impact protection component can include a channel for routing a strap for securing the impact protection component to the vehicle. The impact protection component can include a tensioning mechanism. The impact protection component can include a mat for receiving the animal containment unit. The mat can be selectively deployable between an extended configuration and a stowed configuration. The mat can be comprised of a plurality of hinged sections. The mat can include at least one of a rail or recess for retaining the animal containment unit thereon.

In accordance with another aspect, an animal containment unit for installation in a vehicle comprises a base, at least one side panel extending upward from the base and having a thickness, and a front panel extending upward from the base, the front panel comprising an exterior panel and an impact panel resulting in a greater thickness in the front panel than in the at least one side panel.

The animal containment unit can further include comprise ribs extending between the front panel and the impact panel.

In accordance with another aspect, an animal containment unit for installation in a cargo area of a vehicle comprises two or more sidewalls extending from a base, the two or more sidewalls comprising a first sidewall having a door and a second sidewall having a connection mechanism configured to connect to an exterior component to anchor the animal containment unit, a first actuator configured to open the door, and a second actuator configured to release the connection mechanism.

The first actuator and the second actuator can be mounted to the same sidewall of the two or more sidewalls. The first actuator and the second actuator can be mounted to the first sidewall. The second sidewall can be located opposite to the first sidewall.

In accordance with another aspect, a system comprises an animal containment unit and an impact protection component. The animal containment unit includes two or more sidewalls extending from a base, the two or more sidewalls comprising a first sidewall having a door and a second sidewall having a connection mechanism configured to connect to an exterior component to anchor the animal containment unit, a first actuator configured to open the door, and a second actuator configured to release the connection mechanism, wherein the impact protection component is at least partially positionable between a seat back portion of a vehicle and the animal containment unit, and wherein the connection mechanism of the animal containment unit is configured to releasably connect to the impact protection component.

In accordance with another aspect, a method of assembly of an animal containment unit, comprises attaching first and second side panels to a base, attaching a top panel to the first and second side panels, attaching a rear panel by sliding two or more stubs of the rear panel into corresponding receivers proximate the top panel and the base, and attaching a front panel by sliding two or more stubs of the front panel into corresponding receivers proximate the top panel and the base.

In accordance with another aspect, an animal containment system comprises an animal containment unit having a first connection mechanism, and an impact protection component being at least partially positionable between a seat back portion of a vehicle and the animal containment unit, the impact protection component having: a second connection mechanism for selectively attaching to the first connection mechanism, and an anchoring device for mounting the impact protection component to the vehicle.

### BRIEF DESCRIPTION OF THE DRAWINGS

The following description of the illustrative embodiments may be better understood when read in conjunction with the appended drawings. It is understood that potential embodiments of the disclosed systems are not limited to those depicted.

FIG. 1 is a side view of an exemplary animal containment unit in accordance with the present disclosure.

FIG. 2 is a perspective view of an exemplary docking station in accordance with the present disclosure.

FIG. 3a is a perspective view of an exemplary animal containment system in accordance with the present disclosure.

FIG. 3b is an overhead perspective view of the animal containment system of FIG. 3a.

FIG. 3c is a sideview of the animal containment system of FIG. 3a.

FIG. 4 is a perspective view of the animal containment system of FIG. 3a with ramp deployed.

FIG. 5 is a perspective view of another exemplary docking station in accordance with the present disclosure.

FIG. 6a is a perspective view of another exemplary animal containment system in accordance with the present disclosure.

FIG. 6b an overhead perspective view of the animal containment system of FIG. 6a.

FIG. 7 is a flowchart of a method in accordance with the present disclosure.

FIG. 8 is a perspective view of another exemplary animal containment unit in accordance with the present disclosure.

FIG. 9 is a side view of the animal containment unit of FIG. 8.

FIG. 10 is a side view of the animal containment unit of FIG. 8.

FIG. 11 is a perspective view of another exemplary docking station in accordance with the present disclosure.

FIG. 12 is a perspective view of the exemplary docking station of FIG. 11 in a vehicle.

FIG. 13 is a perspective view of another exemplary animal containment unit in accordance with the present disclosure.

FIG. 14 is a sideview of the animal containment unit of FIG. 13.

FIG. 15 is a perspective view of another exemplary animal containment system in accordance with the present disclosure.

FIG. 16 is a perspective view of another exemplary animal containment system in accordance with the present disclosure.

FIG. 17 is a sideview of the animal containment system of FIG. 16.

FIG. 18 is a perspective view of the animal containment system of FIG. 16.

FIG. 19 is a side view of another exemplary animal containment unit in accordance with the present disclosure.

FIG. 20 is a side view of the animal containment unit of FIG. 19.

FIG. 21 is a perspective view of an exemplary animal containment system including a bumper protector in a stowed state.

FIG. 22 is a perspective view of the animal containment system of FIG. 21 with the bumper protector deployed.

FIG. 23 is a perspective view of an organizer mounted to a docking station in accordance with the present disclosure.

FIG. 24 is a perspective view of another exemplary animal containment system in accordance with the present disclosure.

FIG. 25 is a perspective view of another exemplary animal containment unit in accordance with the present disclosure.

FIG. 26 is a side view of the animal containment unit of FIG. 25.

FIG. 27 is a side view of the animal containment unit of FIG. 25.

FIG. 28 is a perspective view of another exemplary animal containment system including an impact protection component in accordance with the present disclosure.

FIG. 29 is a cross-sectional view of the animal containment system of FIG. 28 taken along the line 29--29.

FIG. 30 is a perspective view of an exemplary impact protection component in accordance with the present disclosure.

FIG. 31 is a sideview of the impact protection component of FIG. 30.

FIG. 32 is a partial perspective view of the impact protection component of FIG. 30 from a section taken along the line 32- 32.

FIG. 33 is a perspective view of another exemplary impact protection component in accordance with the present disclosure.

FIG. 34 is another perspective view of the impact protection component of FIG. 33.

FIG. 35 is a cross-sectional view of an exemplary animal containment system having a first latch mechanism in accordance with the present disclosure.

FIG. 36 is an enlarged portion of FIG. 35.

FIG. 37 is a perspective view of the latch mechanism.

FIG. 38 is a cross-sectional view of an exemplary animal containment system having a second latch mechanism in accordance with the present disclosure.

FIG. 39 is an enlarged portion of FIG. 38.

FIG. 40 is a cross-sectional view of an exemplary animal containment system in accordance with the present disclosure.

FIGS. 41 and 42 are perspective views of another exemplary impact protection component in accordance with the present disclosure.

FIGS. 43 and 44 are perspective views of another exemplary impact protection component in accordance with the present disclosure.

FIGS. 45 and 46 are perspective views of another exemplary impact protection component in accordance with the present disclosure.

FIGS. 47, 48 and 49 are perspective views of another exemplary impact protection component in accordance with the present disclosure.

FIG. 50 is a top view of the impact protection component of FIGS. 47, 48 and 49 with certain parts omitted for clarity.

FIG. 51 is a sideview of another exemplary animal containment system in accordance with the present disclosure.

FIG. 52 is an overhead perspective view of the animal containment system of FIG. 51.

FIG. 53 is a perspective view of the animal containment system of FIG. 51.

FIG. 54 is an overhead perspective view of another exemplary animal containment system including an impact protection component in accordance with the present disclosure.

FIG. 55 is a perspective view of the animal containment system of FIG. 54.

FIGS. 56 and 57 are perspective views of another exemplary impact protection component in accordance with the present disclosure.

FIGS. 58-62 are perspective views of different exemplary impact protection components in accordance with the present disclosure.

FIG. 63 is a perspective exploded view of another animal containment unit in accordance with the present disclosure.

FIGS. 64-66 are perspective views showing the animal containment unit of FIG. 63 in various stages of assembly.

FIG. 67 is a perspective view of the disassembled animal containment unit.

FIG. 68 is a sideview of the disassembled animal containment unit.

FIG. 69 is a partial cutaway view showing an exemplary latch mechanism for joining panels of an animal containment unit.

FIG. 70 is another partial cutaway view of the latch of FIG. 69.

FIG. 71-73 are cross-sectional views of a cam bolt assembly for joining panels of an animal containment unit.

FIG. 74 is a cross-sectional view of another exemplary animal containment unit in accordance with the present disclosure.

FIG. 75 is a perspective view of an impact panel in accordance with the present disclosure.

FIGS. 76 and 77 are cross-sectional views of another exemplary animal containment unit in accordance with the present disclosure.

FIG. 78 is a partial view of an exemplary door latch mechanism with certain parts omitted in accordance with the present disclosure.

FIG. 79 is a perspective view of the door latch mechanism of FIG. 78

FIG. 80 is a cross-sectional view taken through a handle (actuator) of the door latch mechanism of FIG. 78.

FIG. 81 is a cross-sectional view taken through a latch of the door latch mechanism.

FIG. 82 is an exploded view of another exemplary animal containment unit in accordance with the present disclosure.

### DETAILED DESCRIPTION

The present disclosure sets forth various aspects of a pet containment system for a vehicle including a containment structure for containing a pet. The pet containment system is mountable in a vehicle

It should be noted that the illustrations and descriptions of the examples and embodiments shown in the figures are for exemplary purposes only, and should not be construed limiting the disclosure. One skilled in the art will appreciate that the present disclosure contemplates various embodiments. Additionally, it should be understood that the concepts described above with the above-described examples and embodiments may be employed alone or in combination with any of the other examples and embodiments described above. It should further be appreciated that the various alternative examples and embodiments described above with respect to one illustrated embodiment can apply to all examples and embodiments as described herein, unless otherwise indicated.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The exemplary embodiments may be further understood with reference to the following description and the related appended drawings, wherein like elements are provided with the same reference numerals. The exemplary embodiments describe an assembly for safely transporting animals, e.g., large dogs, in a vehicle cargo area. In some embodiments, the assembly features a docking station attachable to the vehicle via flexible tethers and/or a rigid support structure. The docking station can be installed in any suitably sized cargo area of a vehicle, for example, an SUV, crossover or hatchback vehicle. An animal containment unit, e.g., crate, for holding the animal can be attached or locked to the docking station to securely transport the animal in the vehicle.

In one embodiment, the assembly for animal containment includes an animal containment unit and a docking station. The animal containment unit may be referred to alternatively as a crate, a dog crate, etc. Those skilled in the art will understand that the animal containment unit is configured to safely hold an animal during, e.g., transportation of the animal in a moving vehicle and/or for transportation of the animal outside the vehicle. The docking station is detachable from the animal containment unit so that the docking station may be left installed in the vehicle while the animal containment unit is removed therefrom and reinstalled on the docking station at a later time.

The docking station may be referred to alternatively as a dock, a base, etc. The docking station can be securely installed in the vehicle via flexible tethers and/or rigid support structure. In some embodiments, the docking station features a telescoping ramp to aid in the loading and unloading of the animal containment unit (e.g., a crate) or dog into the vehicle. The crate can feature wheels and a handle for ease of moving and has features for securely attaching to corresponding features of the docking station. The handle can also serve as a structural load leg in the event of a vehicle accident.

It should be understood that the assembly can be installed in a vehicle, e.g., in the cargo area of an SUV, crossover or hatchback vehicle.

In the following description, the terms “front” and “rear” are generally used with respect to a front and rear of a vehicle in which aspects of the present disclosure are used or intended to be used, unless otherwise stated. Thus, for example, a rear of a docking station is oriented toward a rear of vehicle or refers to a portion of the docking station intended to be orientated towards a rear of a vehicle.

It should be further understood that reference to a “side” of the assembly, the unit or the docking station is provided for ease of explanation, and that multiple different components of the assembly can define the exterior of the assembly and these exterior components are not necessarily orthogonal to the other “sides.” Additionally, the terms “inside” and/or “interior” and/or “internal” may refer to features in a direction toward the center of the assembly, relative to a certain component of the assembly, and the terms “outside” and/or “exterior” and/or “external” may refer to features in a direction away from the center of the assembly, relative to a certain component of the assembly.

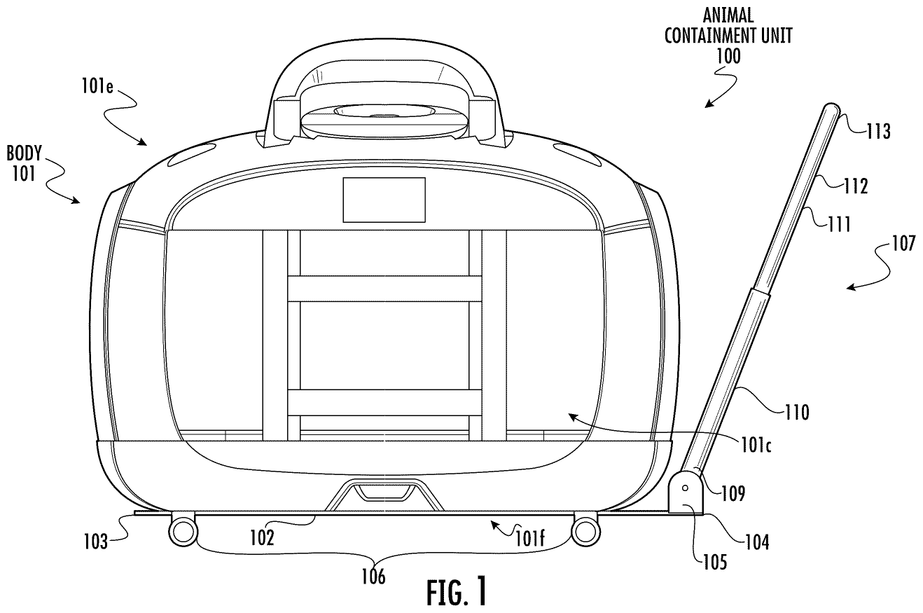

The animal containment unit or crate can be formed in a variety of ways. One example of an animal containment unit is provided below in FIG. 1. It is noted that only certain features of the crate, specifically, a support plate on the bottom of the crate, wheels on the bottom of the plate, and a telescoping handle rotatably coupled to the front of the plate via brackets, are described in detail below according to the present embodiments. Those skilled in the art will ascertain that the exemplary embodiments can be applied with different types of crates.

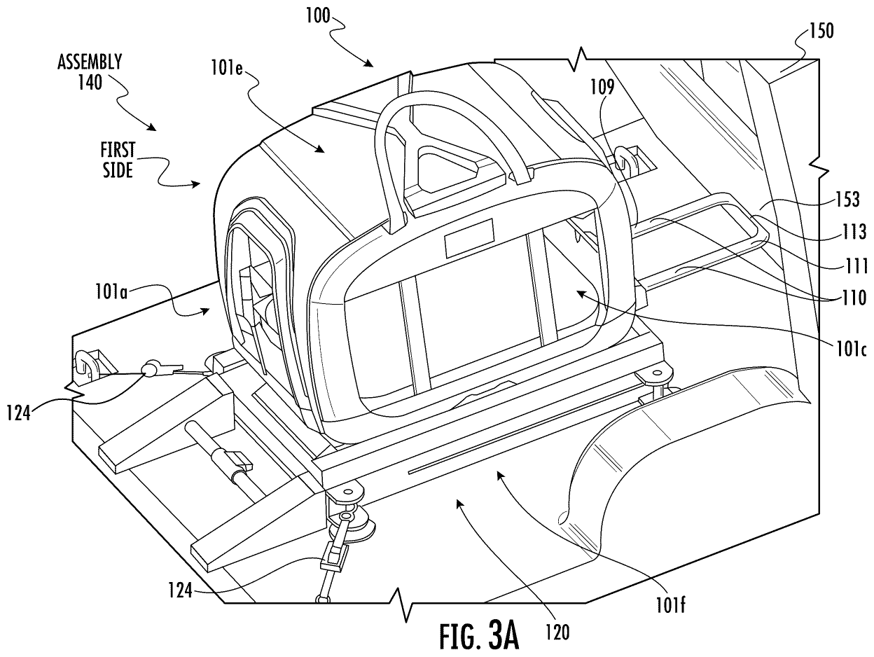

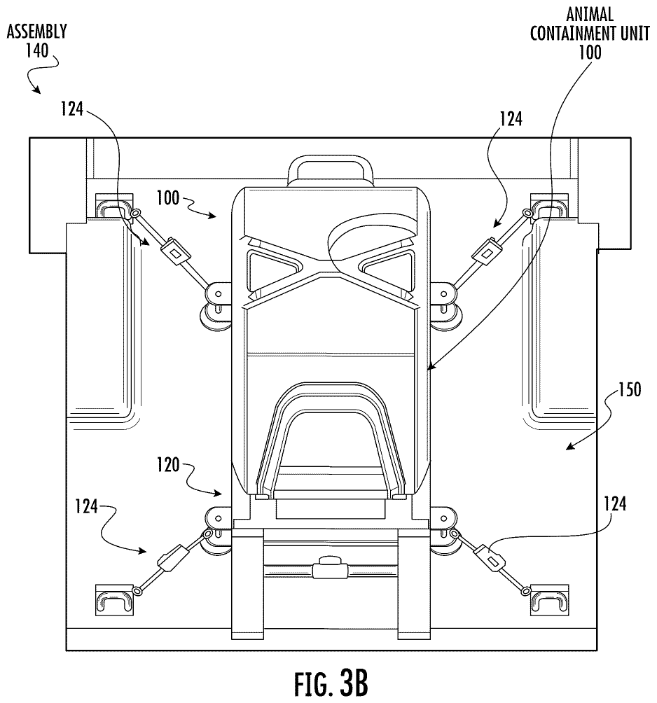

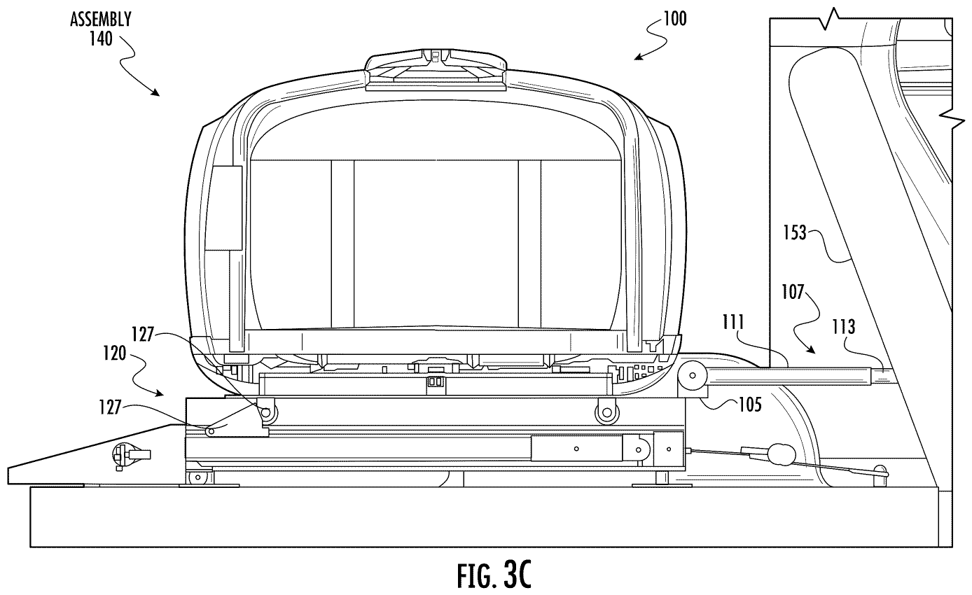

FIGS. 1 and 3a show an animal containment unit 100 according to various exemplary embodiments. The animal containment unit 100 includes a plurality of sides (e.g., six sides) and is described with regard to a first side 101a (e.g., a left side in the view of FIG. 3a), a second side 101b, a third side 101c, a fourth side 101d, a top side 101e, and a bottom side 101f. These sides for the animal containment unit 100 are labeled in FIGS. 1 and/or 3a and these labels are omitted in the subsequent figures. It is noted that FIG. 1 shows a side view from second (right) side of the animal containment unit 100 and the first (left) side of the animal containment unit 100 is obscured by the second side.

The animal containment unit 100 generally comprises a body 101, e.g., a crate portion for securely holding an animal, that can be formed in a variety of manners. In one example, the body 101 comprises a frame structure, a base, containment materials (e.g., soft goods enclosing the interior of the unit), and support webbing. The frame structure can include support members. In one of the exemplary embodiments, the animal containment unit 100 of FIG. 1, shown in greater detail in, e.g., FIGS. 3a-b, the frame structure includes an X-bar extending from the first side across the top to the second side connecting two U-shaped support members on the first and second sides. The frame structure of this embodiment includes actuators for collapsing the frame when the animal containment unit 100 is not in use.

The containment materials define the exterior and interior surfaces of the body 101 and can be supported by the frame structure. There is at least one door formed in the containment materials, e.g., on the fourth side 101d of the animal containment unit 100, for loading an animal in and unloading an animal from the animal containment unit 100. There may also be one or more windows formed in the containment materials to permit observation of the animal therein and to permit the animal to see out. The base of the body 101 of this embodiment rigidly supports the frame structure and includes actuators for various functionalities of the crate, e.g., collapsing the body 101. In this example, the body 101 further includes a top handle, e.g., for lifting the animal containment unit 100.

The above example of the body 101 of the animal containment unit 100 is provided only for illustrative purposes. Those skilled in the art will ascertain that the exemplary embodiments can be applied with different types of crates.

According to one aspect of these exemplary embodiments, the animal containment unit 100 includes a plate 102 or base member fixed to the exterior of the bottom of the body 101, e.g., on the exterior surface of the base of the body 101. The plate 102 extends from a first end to a second end 104 and across the bottom of the body 101 from the first side to the second side. The first end 103 and the sides are substantially covered by the bottom of the body 101 so that, in this embodiment, the plate 102 does not protrude beyond the fourth side 101d of the body 101 or past the other sides. The second end 104 extends past the front of the body 101 by a distance sufficient for brackets 105 to be formed or provided on the top sides of the second end 104 of the plate 102.

The animal containment unit 100 may also include a handle 107 (e.g., a telescoping handle) for ease of moving. The animal containment unit 100 may include a plurality of wheels 106 (e.g., four wheels). The wheels 106 may be located on the bottom of the plate 102. The wheels 106 may include at least one rear wheel (e.g., preferably two rear wheels) which may be located at positions adjacent to the fourth side 101d of the body 101 and at least one front wheel of the wheels 106 (e.g., preferably two front wheels) which may be located at positions adjacent to the second side 101b of the body 101. The wheels 106 and/or other structure of the plate 102 and/or body 101 can be used to lock the animal containment unit 100 to a docking station 120 as described in greater detail below.

The handle 107 can extend from a first end 108 (see FIG. 1) rotatably coupled to a first of the brackets 105 (not shown in FIG. 1) on the first side of the plate 102 to a second end 109 (see FIG. 3a) rotatably coupled to a second bracket on the second side of the plate 102. The handle 107 can have first members 110 rotatably coupled to the brackets 105 and a second member 111 shaped, in this embodiment, like a U comprising sliding members 112 slidably coupled to the first members to adjust the length of the handle 107 and an engagement member 113 connecting the sliding members 112 suitable for grasping by a user. The sliding members 112 in this example have outer dimensions that correspond to inner dimensions of the first members 110 so that the sliding members 112 are telescopically slidable within the first members 110. The handle 107 also serves as a structural load leg to secure the animal containment unit 100 with the vehicle 150 in the event of an accident by engaging the engagement member 113 with an interior surface of the vehicle 150, to be described in greater detail below.

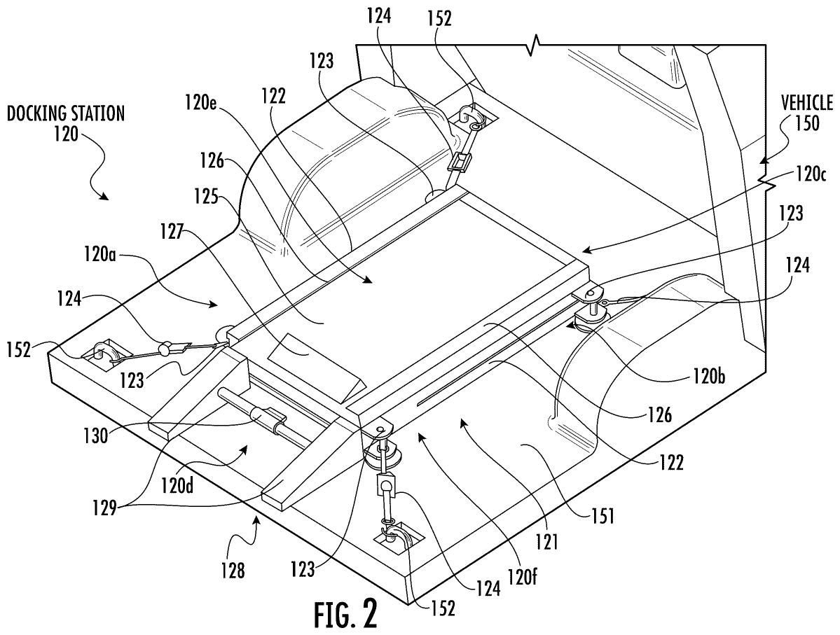

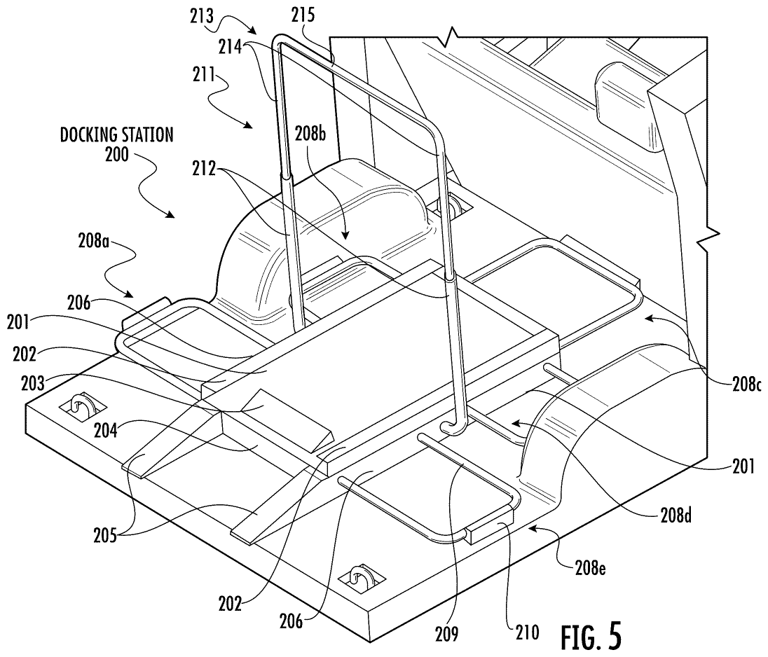

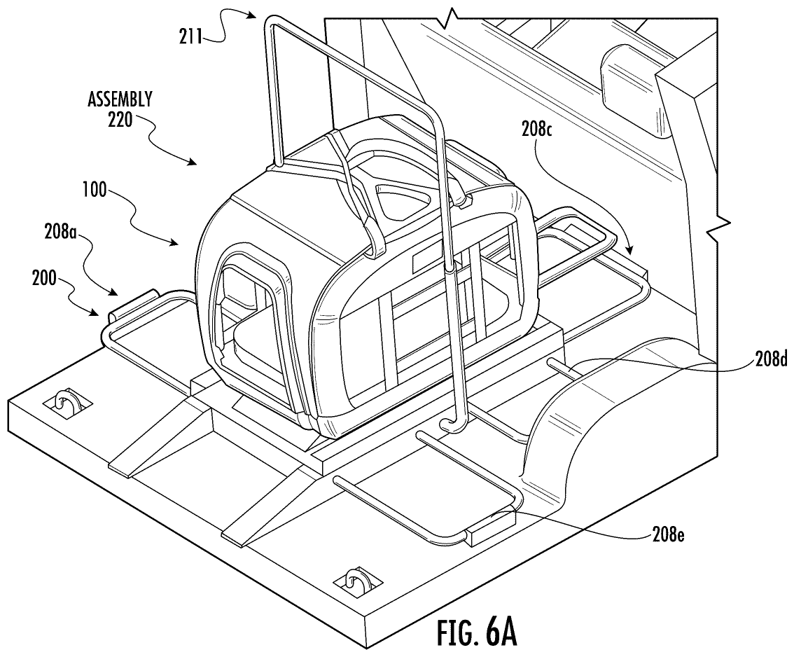

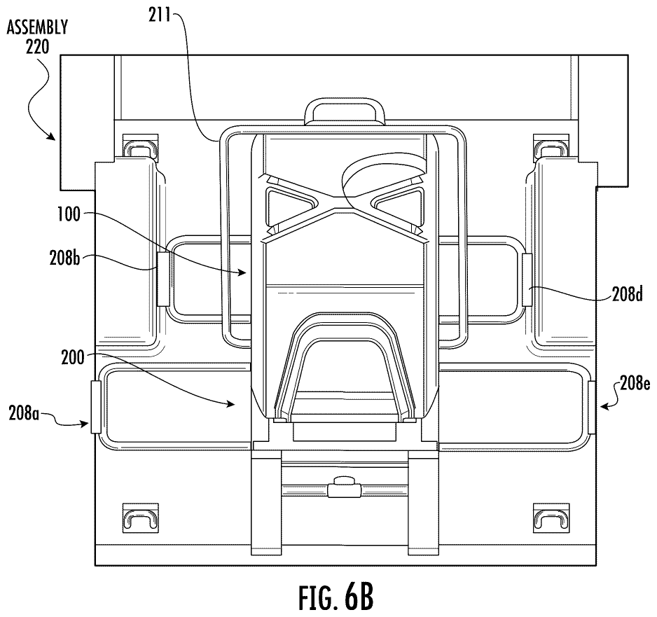

As described above, the animal containment unit 100 of this embodiment can be securely attached to the docking station 120 installed in the vehicle 150 and, later, detached therefrom. The docking station 120 may include flexible tethers 124 according to a first exemplary embodiment which is illustrated in FIGS. 2, 3a-c and 4. The docking station 120 may include a rigid support structure (securing structure) according to a second exemplary embodiment described in FIGS. 5 and 6a-b. Due to the secure attachment of the containment unit 100 on the docking station 120, along with the securing structures for the docking station such as tethers and load legs discussed below, the docking station may generally be referred to as an “impact protection component” for the animal containment unit that is used to protect both human and animal occupants of a vehicle during a crash.

FIG. 2 shows the docking station 120 with flexible attachments for installation in the vehicle 150 according to various exemplary embodiments. The docking station 120 is described in a similar convention as the animal containment unit 100 with a first side 120a (e.g., a left side in the view of FIG. 2), a second side 120b, a third side 120c, a fourth side 120d, a top side 120e, and a bottom side 120f. The docking station 120 allows for a secure connection between the animal containment unit 100 and the vehicle 150, while allowing ample room in the cargo area when not in use as well as a quick and easy way to install and remove the animal containment unit 100.

The docking station 120 may include a base 121 which may have a flat bottom surface (not shown) configured to rest on a flat surface in the vehicle 150, e.g., a cargo area. The base 121 may further include side surfaces 122 extending from the front to the rear of the base 121 with brackets 123 at the ends (e.g., four of the brackets 123). The brackets 123 of this embodiment comprise anchor points for tethers 124 (e.g., flexible tethers). The tethers 124 extend from a first end attached at the bracket 123 to a second end that can attach to anchor points 152 within the cargo area of the vehicle 150. The tension of the tethers 124 can be adjusted and the tethers 124 may each be locked so that tension is applied between the respective one of the bracket 123 and the anchor point 152. Accordingly, the docking station 120 can be installed securely prior to loading the animal containment unit 100 into the vehicle 150.

The base 121 may further include a top surface 125 that engages the animal containment unit 100. The top surface 125 can include L brackets 126 extending along its first and second sides configured to guide the animal containment unit 100 into a locked configuration with the docking station 120. The L brackets 126 are separated from one another by a distance slightly smaller than a distance from the first side to the second side of the animal containment unit 100 such that the exterior surface of the body 101 at the bottom side corners extending from the front to the back of the animal containment unit 100 can engage the top inner surfaces of the L brackets 126 and be aligned for locking with the docking station 120. A latch 127 is provided on the rear of the top surface 125 to receive the rear wheels of the wheels 106 of the animal containment unit 100, to be described in greater detail below.

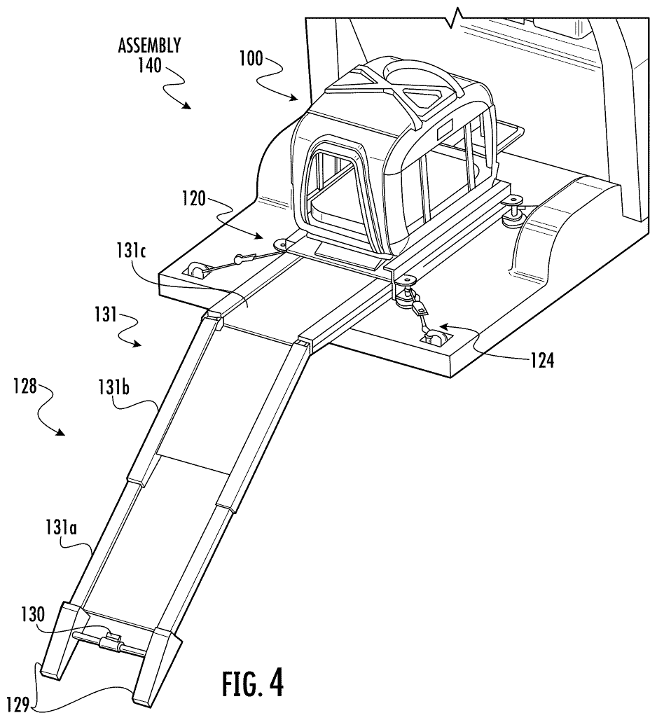

The rear of the base 121 is open and provides access to a cavity (not shown) in which extensions 131a/131b/131c of a ramp 128 (e.g., a telescoping ramp) are stored when the ramp 128 is not deployed, as shown in FIG. 2. The ramp 128 in an extended or deployed state is described below with regard to FIG. 4. The ramp 128 includes a rear portion which may include inclined members 129 (e.g., preferably two members) and a handle 130 (e.g., a transverse member) connecting the inclined members 129. The handle 130 may be gripped by a user and the extensions 131a/131b/131c of the ramp 128 can be withdrawn in succession, to be described below. The front of the base 121 in this example is closed.

FIGS. 3a-c show an assembly 140 including the animal containment unit 100 of FIG. 1 connected to the docking station 120 of FIG. 2 according to various exemplary embodiments.

To connect the animal containment unit 100 to the docking station 120 the docking station 120 may include, for example, a T-track (not shown) in lieu of the L brackets 126, and the animal containment unit 100 may include a corresponding T-member (not shown) configured to connect the animal containment unit 100 to the docking station 120. One or more wheels of the wheels 106 are configured to be received in the latch 127 of the docking station 120, as shown in FIG. 3c, to restrict sliding movement of the animal containment unit 100 relative to the docking station 120. The handle 107 is rotatable so that the handle 107 can extend horizontally from the brackets 105 and the second member 111 may be withdrawn (e.g., pulled towards the front of the vehicle 150 so that the second member 111 is extended relative to the first members 110) so that the engagement member 113 contacts a rear-facing surface 153 of the vehicle 150. The handle 107 can be locked in this configuration so that the handle 107 aids to secure the animal containment unit 100 within the vehicle 150. The handle 107 may progressively lock as the second member 111 is withdrawn relative to the first members 110. The handle 107 can be unlocked and its length shortened by a release actuator at the brackets 105 or in any other known manner.

FIG. 4 shows the ramp 128 of the docking station 120 of FIG. 2 in an extended state according to various exemplary embodiments. In this example, the ramp 128 includes three extensions 131a/131b/131c nested within each other. The first extension 131a is attached to the inclined members 129 and can slide within a second extension 131b or slide out (forward) relative to the second extension 131b while remaining attached to the second extension 131b at a rear end of the first extension 131a. The second extension 131b is configured to slide within a third extension 131c or to slide out relative to the third extension 131c. The third extension 131c is also configured to slide within the cavity of the docking station 120 with the first and second extensions 131 a and 11 b nested inside. When the extensions 131a/131b/131c are extended (slid out), one or more of the extensions 131a/131b/131c are rotatable relative to each other such that the extensions 131a/131b/131c can be coextensive or can be oriented at an angle relative to one another. As shown in FIG. 4, the first and second extensions 131a and 131b are angled relative to the third extension 131c.

In FIG. 5, a second embodiment of the docking station 120 includes rigid support members. FIG. 5 shows a docking station 200 with rigid support members according to various exemplary embodiments. The docking station 200 may include a base 201 including a flat bottom surface (not shown) that rests on a flat surface in the vehicle 150, e.g., a cargo area, similar to the docking station 120 described above. A top surface includes L brackets 202 and a latch 203 similar to those of the docking station 120 described above. In this example, a rear surface 204 of the base 201 is closed and inclined members 205 (e.g., preferable two inclined members) similar to the inclined members 129 of the docking station 120, extend directly from the rear surface 204. Thus, in this example, there is no telescoping ramp.

The base 201 includes side surfaces 206 and a back surface (not shown) that are closed but comprise holes configured to permit members 208 (e.g., horizontal, vertical, and/or angled rigid support members, also referred to as “load legs”) to slidably extend therethrough. In this example, the base 201 comprises five of the members 208 including a first member 208a, a second member 208b, a third member 208c, a fourth member 208d, and a fifth member 208e. The members 208 of this embodiment are generally U-shaped with each having two first members 209 extending orthogonally to a surface of the base 201 and a second member 210 for engaging an interior panel or other surface of the cargo area of the vehicle (labeled for the fifth member 208e and omitted for the other of the members 208).

In this example, a cavity (not shown) in the base 201 is configured to receive the first members 209 when the members 208 are in a stored configuration. The members 208 are configured to be pullable from their corresponding sides of the base 201 so that the members 208 engage the interior panels of the vehicle. The members 208 are configured to progressively lock as they are withdrawn relative to the base 201 using any known mechanism. The members 208 can be unlocked and their length shortened by a release actuator on the base 201 or in any other known manner. In this example, two of the members 208 extend from each of the first and second sides and one of the members 208 extends from the front. Those skilled in the art will ascertain that a greater or lesser number of the members 208 extending horizontally from the base 201 can be used in other designs. In this manner, the members 208 are adaptable to a wide variety of cargo areas shapes and sizes.

Additionally, in this example, a vertical rigid member 211 is included. The vertical rigid member 211 may be telescoping to adjust a height of the vertical rigid member 211 for use in cargo areas of various heights. Two of first members 212 extend out from the sides of the base 201 and turn 90 degrees and a second member 213 shaped like a U has two slidable members 214 configured to be received in the first members 212 or extended out from the first members 212 to adjust a length of the vertical rigid member 211. An engagement member 215 connecting the slidable members 214 is configured to engage the interior surface (top) of the interior of the vehicle. The first members 212 are rotatable relative to the base 201.

To store the vertical rigid member 211, second member 213 is slidable so that the slidable members 214 are received in the first members 212 and the first members 212 can be rotated so that the first members 212 extend toward the front (or rear) of the docking station 200. Similar to above, the telescoping aspect of the vertical rigid member 211 of this embodiment may optionally include a locking mechanism operable to lock the second member 213 at a desired location relative to the first members 212 and the engagement member 215 of the vertical rigid member 211 engages the top surface of the cargo area.

FIGS. 6a-b show an assembly 220 including the animal containment unit 100 of FIG. 1 and the docking station 200 of FIG. 5 according to various exemplary embodiments. Members 208 restrict horizontal movement of the assembly 220 while vertical rigid member 211 restricts vertical movement of the assembly 220.

FIG. 7 shows a method 300 for loading the animal containment unit 100 of FIG. 1 into the vehicle 150 according to various exemplary embodiments. The docking station 120 or the docking station 200 can be used.

In step 305, the docking station 120 or 200 is placed in the cargo area of the vehicle 150. In step 310, the docking station 120 or 200 is secured in the cargo area. If the docking station 120 is used, the tethers 124 of the docking station 120 are attached to anchor points 152 in the cargo area. If the docking station 200 is used, the members 208 and the rigid member 211 can be extended so that each of the members is in abutting contact with an interior surface of the vehicle 150. The members can be locked at a desired extension.

In step 315, the animal containment unit 100 is loaded onto the docking station 120 or 200. The animal containment unit 100 has the wheels 106 and the handle 107 to facilitate transporting the animal containment unit 100 outside the vehicle 150. When the animal containment unit 100 is brought to the top surface of the docking station the exterior bottom surface and/or sides of the animal containment unit 100 can engage the L brackets of the docking station 120 or 200. The wheels 106 can be placed within the latch of the docking station 120 or 200. In one example, a T member of the animal containment unit 100 can engage a T track of the docking station 120 or 200. The handle 107 can be transitioned into a support member by rotating the handle 107 toward the front of the vehicle 150 and extending the telescoping second member of the handle 107 until the second member engages an interior surface of the vehicle 150.

As would be understood by those skilled in the art, the animal containment unit 100 may be loaded into the docking station 120 or 200 with or without an animal contained in the interior. If the docking station 120 is used, the ramp 128 may be extended to facilitate the animal reaching the animal containment unit 100.

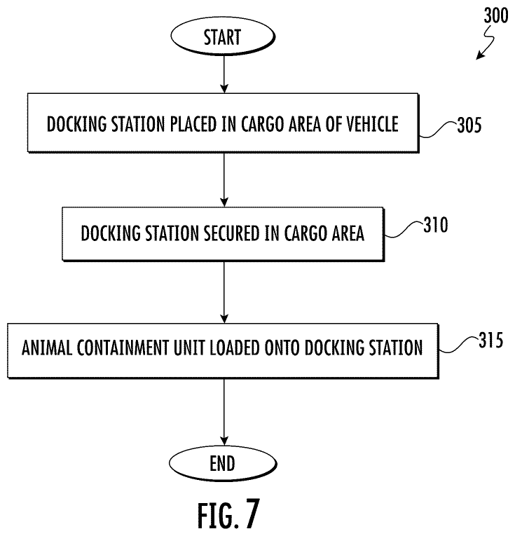

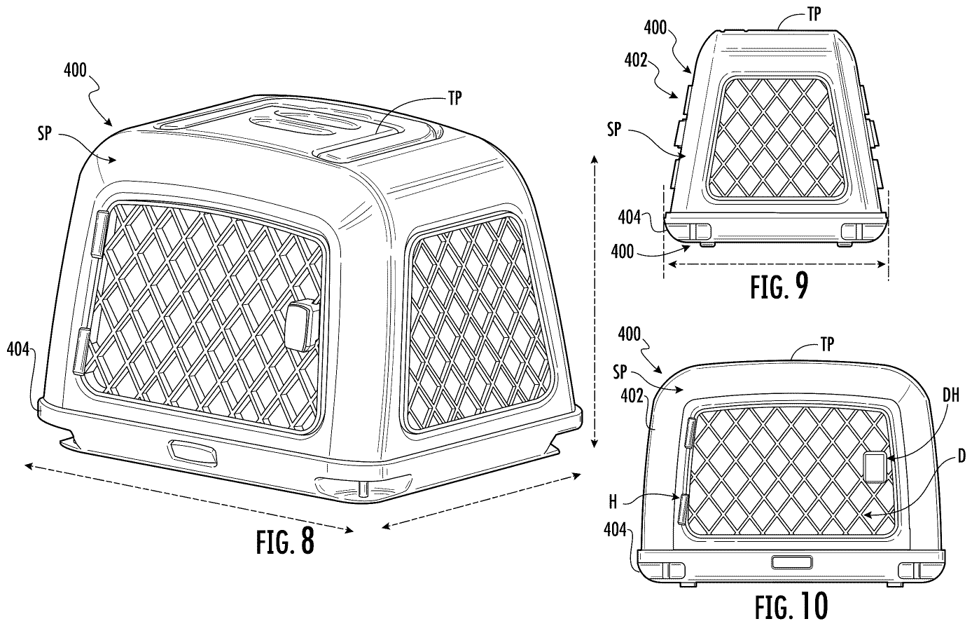

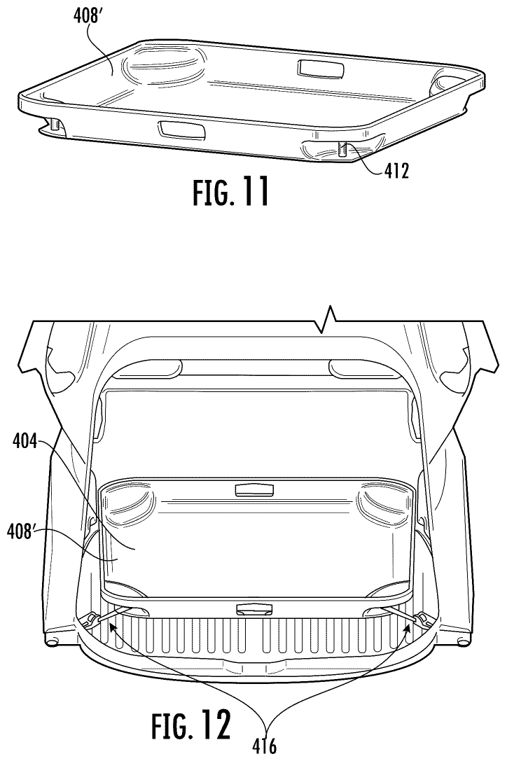

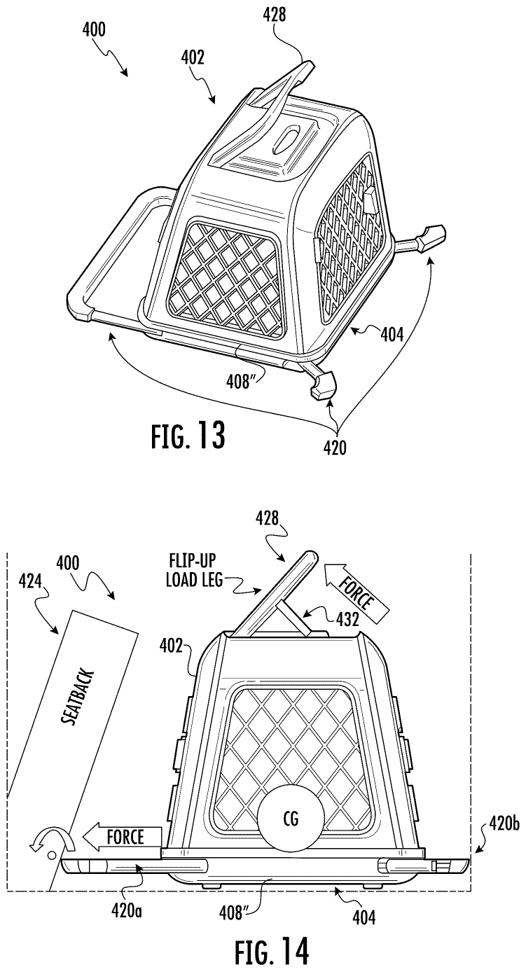

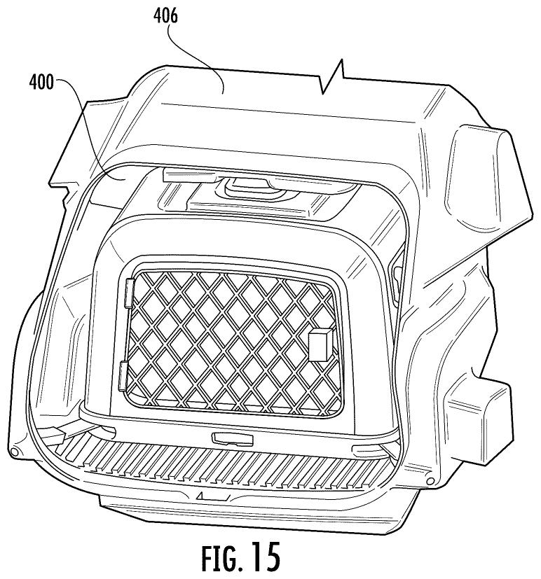

FIGS. 8-15 illustrate another exemplary assembly 400 including an animal containment unit 402 and a docking station 404 for a vehicle 406 in accordance with the present disclosure. The animal containment unit 402 includes a top panel TP, four side panels SP and a bottom panel BP. The animal containment unit 402 includes a door D supported for opening and closing by hinges H. The door D includes a door handle DH which a user may grasp for opening and/or closing the door D. In this embodiment, the docking station 404 generally comprises a tray 408 adapted to be received in a cargo area of a vehicle. In the embodiment of FIGS. 11 and 12, the tray 408′ includes anchor points 412 which can be used in connection with straps 416 to secure the tray 408 to anchors of the cargo area. In the embodiment of FIGS. 13 and 14, the tray 408 includes deployable load legs 420 that are configured to extend outwardly to engages surfaces of the cargo area to restrict horizontal and/or vertical movement of the docking station 404. A front load leg 420a is configured to engage a seatback 424 of a vehicle, while rear load legs 420b are configured to engage side/and or rear interior surfaces of the cargo area. The load legs 420 can be adjustable in length and can include locking mechanisms for selectively securing each load leg 420 in a deployed and/or stowed configuration, and/or for selectively securing each load leg 420 at a desired length. Due to the secure attachment of the containment unit 402 on the docking station 404, along with the securing structures such as tethers and load legs discussed below, the docking station may generally be referred to as an “impact protection component” for the animal containment unit that is used to protect both human and animal occupants of a vehicle during a crash.

In the case of either tray 408′ or 408″, the docking station 404 is secured in the cargo area of the vehicle 406 and the animal containment unit 402 is configured to be selectively securable to the docking station 404. The animal containment unit 402 may include one or more of its own securement features separate from any such features on the docking station. For example, the illustrated embodiment includes an upper load leg 428 that can be deployed from a top panel TP to engage a ceiling surface of the cargo area of a vehicle to restrict vertical and/or forward movement of the animal containment unit 402 and/or docking station 404. The upper load leg 428 in the illustrated embodiment can be rotated to a deployed position to engage the ceiling of the cargo area. A lock arm 432 can secure the upper load leg 416 in the deployed position. When stowed, the load leg 428 may be stowed within a recessed portion of the top panel TP. Additionally or alternatively, one or more load legs may be provided to extend from any one or more panels of the animal containment unit 402, in addition to or in lieu of load legs extending from the docking station 404.

Together, the animal containment unit 402 and the docking station 404 provide a stable enclosure for an animal. When the animal containment unit 402 is removed from the docking station 404, the tray 408′ or 408″ can remain in the vehicle 406 and provides a place for groceries and/or other items, while also serving as a cargo area liner.

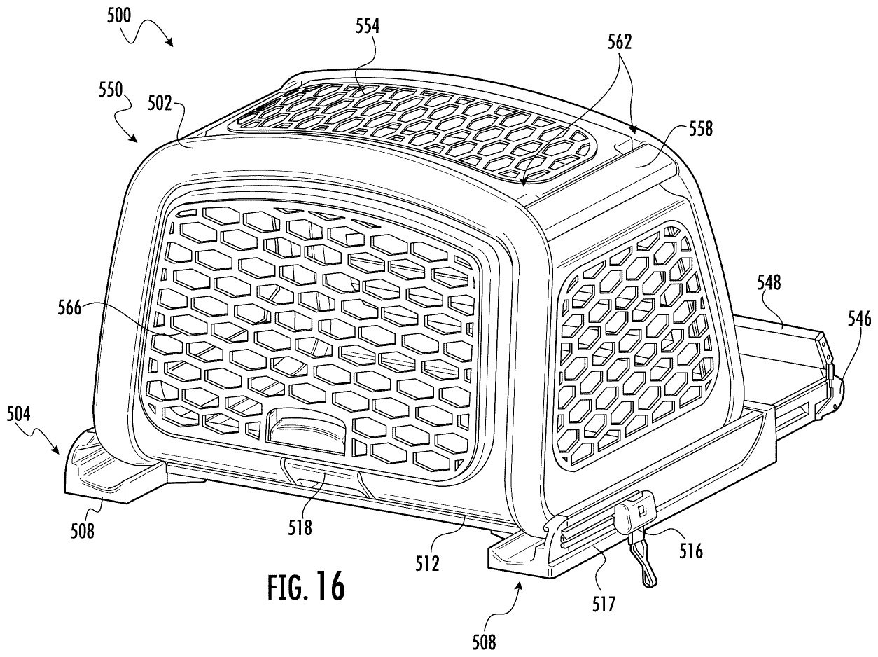

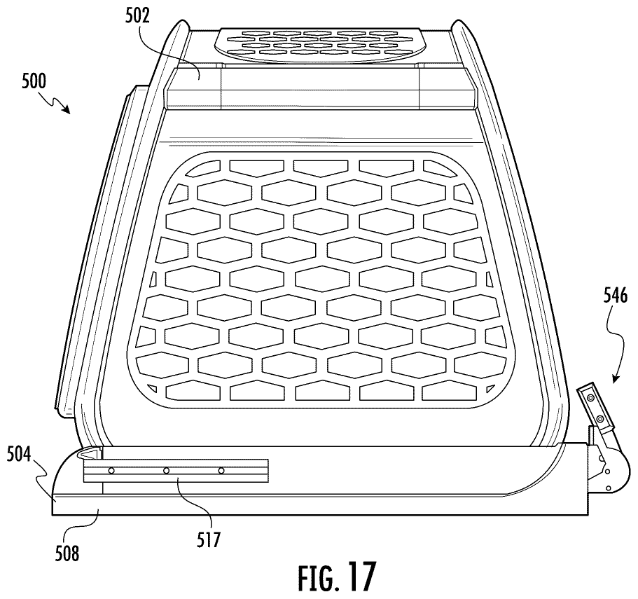

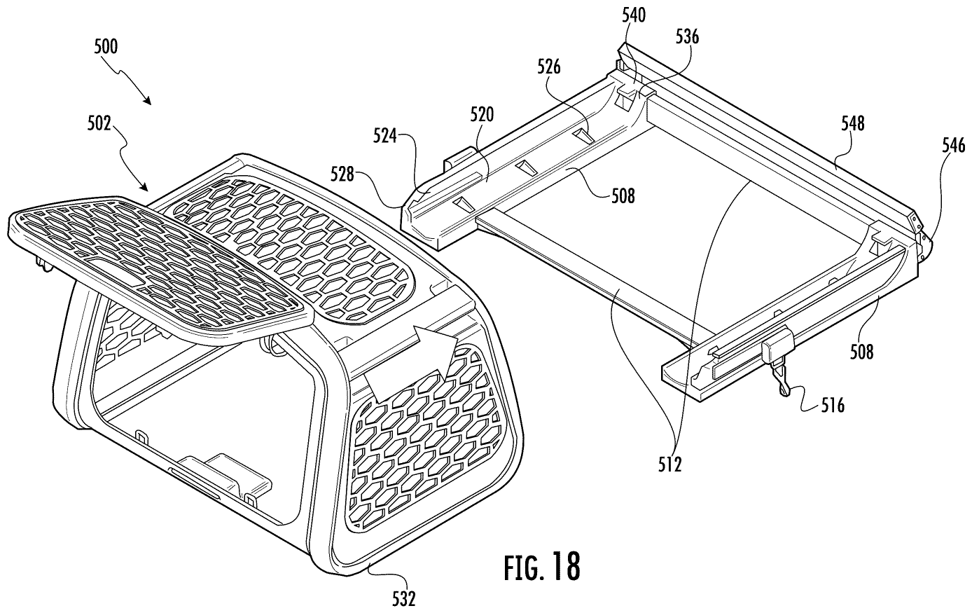

FIGS. 16-18 show another exemplary assembly 500 including an animal containment unit 502 and a docking station 504. In this embodiment, the docking station 504 includes a pair of spaced-apart rails 508 adapted to interlock with portions of the animal containment unit 502. The rails 508 are generally L-shape and joined together by crossmembers 512. Crossmembers 512 can be releasably secured to the rails 508 such that the docking stations 504 can be disabled for storage and/or shipping. Each rail 508 includes a retractable strap 516 for securing to a suitable vehicle anchor point. Each retractable strap 516 is mounted to a track 517 that allows for adjustment of a horizontal position of the retractable strap 516 to better align with a vehicle anchor point. The animal containment unit 502 includes a releasable latch 518 adapted to engage a crossmember 512 to secure the animal containment unit 502 to the docking station 504.

Each rail 508 includes a support surface 520 and side wall 524 adapted to receive and support respective sides of a base portion of the animal containment unit 502. The support surfaces 520 can include rollers 526 and/or low-friction inserts to ease installation of the animal containment unit 502 onto the docking station 504. A bottom surface of each rail 508 can include non-skid feet (not shown). The side wall 524 defines a slot 528 adapted to receive a protrusion 532 of the animal containment unit 502. Each rail 508 further includes an end wall 536 having a hook 540 adapted to be received in corresponding recesses 544 in the animal containment unit 502. When the latch 518 is engaged with the crossmember 512, protrusions 532 are received in the slots 528, and the hooks 540 are received in the recesses 544, vertical and horizontal movement of the animal containment unit 502 relative to the docking station 504 is restricted. The mounting structure (e.g., slots 528 and hooks 540) only extend for a minority portion of the rails 508 to allow a user more freedom in initially placing the animal containment unit 502 most of the way into a vehicle, then aligning the animal containment unit 502 on the rails 508, and then fully inserting the animal containment unit 502 into the docking station 504.

It will be appreciated that a wide variety of interlocking and/or cooperating structures can be provided for securing the animal containment unit 502 to the docking station 504.

The docking station 504 includes a retractable load leg 546. The retractable load leg 546 extends from each rail 508 and includes a spring-loaded engagement member 548 adapted to engage a seatback of the vehicle. The spring-loaded engagement member 548 can pivot to accommodate various seatback angles. The retractable load leg 546 can include impact-absorbing features. In one embodiment, one or more gas dampers can be provided to dissipate energy when collision forces are applied to the load leg 546. The retractable load leg 546 can telescope from the rails 508.

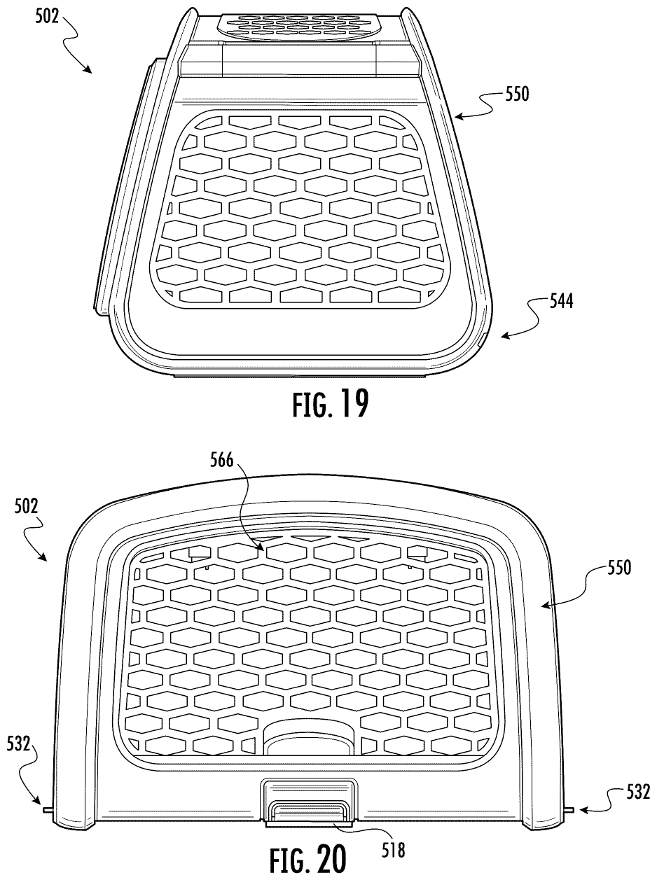

With reference to FIGS. 19 and 20, the animal containment unit 502 in this embodiment includes an aluminum tube frame 550 that may be a continuous exo-skeleton structure that provides structural rigidity. Plastic body panels 554 extend between portions of the aluminum tube frame 550 and define an interior of the animal containment unit 502. The plastic panels can be overmolded with energy absorbing materials to dissipate energy in the event of a collision. Carry handles 558 are provided for lifting the animal containment unit 502, and openings 562 allow the unit 502 to be installed with tether straps is situations where a docking station in not used or when additional security is desired. The rear of the animal containment unit 502 include an upwardly opening door 566 (e.g., a liftgate).

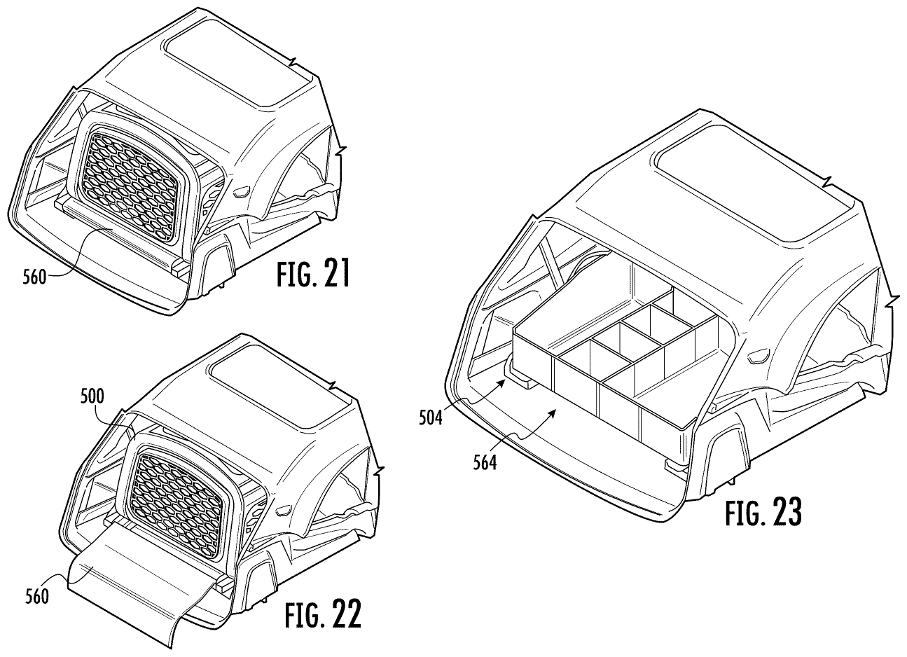

With additional reference to FIGS. 21 and 22, the docking station 504 can include a retractable bumper protector 560. The retractable bumper protector 560 can include a retractable reel-mounted bumper protector.

FIG. 23 illustrates the docking station 504 in use in conjunction with an organizer 564. The organizer 564 can include similar features to the animal containment unit 502 for coupling with the docking station 504. When the animal containment unit 504 is not being used, the organizer 564 can be installed to the docking station 504 to provide additional utility to the assembly 500.

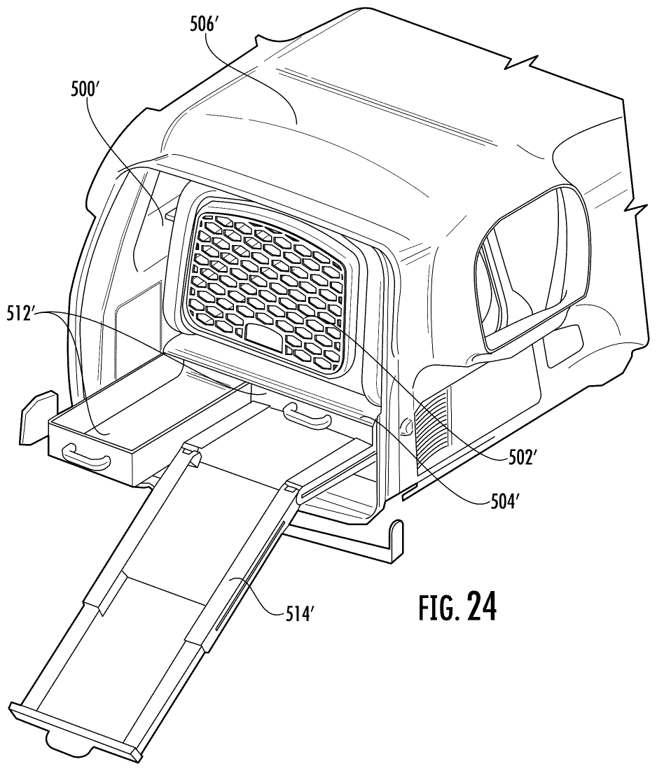

FIG. 24 illustrates another exemplary assembly 500′ including an animal containment unit 502′ and a docking station 504′ installed in a cargo area of a vehicle 506′. The animal containment unit 502′ and the docking station 504′ are generally identical to the animal containment unit 502 and the docking station 504 of assembly 500, with the exception that the docking station 504′ includes a storage area that can include, for example, organizer drawers 512′ and an extendable ramp 514′.

It should be appreciated that the various embodiments described thus far provide an animal containment unit (crate) including a docking station which is attached to the vehicle via flexible tethers or rigid support structure (e.g., docking station). The docking station can feature a telescoping ramp to aid in the loading and unloading of the crate or dog into the vehicle. The crate features wheels and a handle for ease of moving. The handle can also serve as a structural load leg during a vehicle accident.

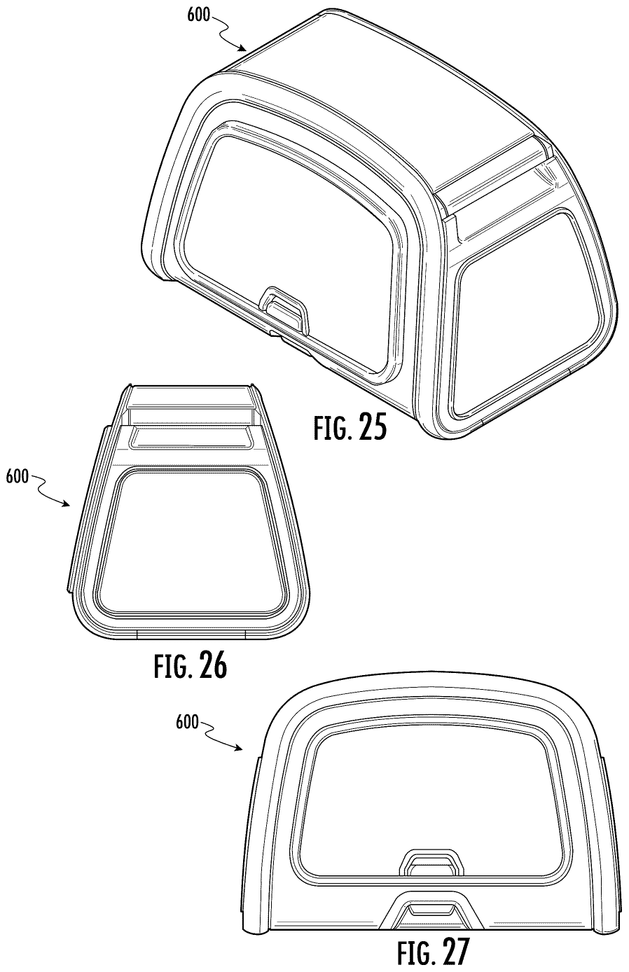

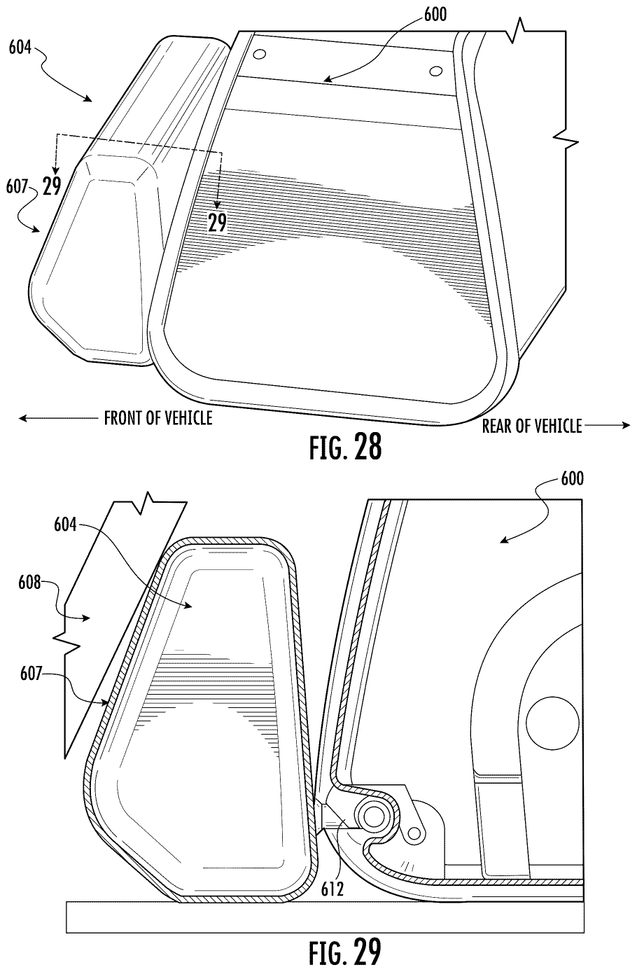

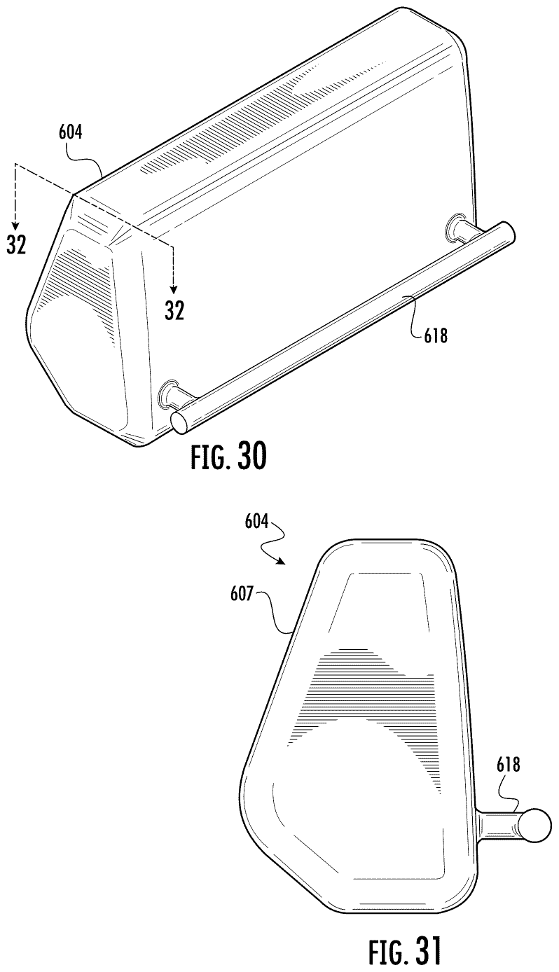

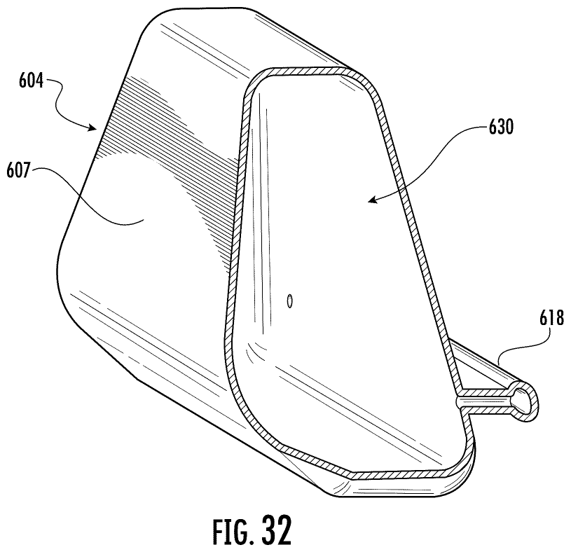

FIGS. 25-27, illustrate an animal containment unit 600. With additional reference to FIGS. 28-29, an impact protection component in the form of a wedge dock 604 is connected to the animal containment unit 600. The wedge dock 604 is configured to be interposed in a space between a seatback 608 of a vehicle and the animal containment unit 600 and coupled to the animal containment unit 600 by a wedge lock mechanism 612. FIGS. 30-32 illustrate the wedge dock 604 alone. The wedge dock 604 includes a contact surface 607 that is angled to match or approach a slope of the seatback. The wedge dock 604 is coupled to the animal containment unit 600 via a coupling bar 618, which is described in more detail below. The wedge dock 604 provides, among other things, secure and convenient positioning of the animal containment unit 600 in a cargo areas of a vehicle, shock absorbing capabilities to reduce or otherwise mitigate the effects of a vehicle collision, and/or storage features. Together, the animal containment unit 600 and the wedge dock 604 define an animal containment system 606.

The impact protection component can comprise, for example, aluminum. In an aspect, the impact protection component defines a hollow cavity 630. The hollow cavity can be empty (include only air), or alternatively, the hollow cavity can receive a shock absorbing material or structure, such as rubber, foam, honeycomb, or other absorbing material or structure. During a collision, the impact protection component is configured to absorb some of the force between the animal containment unit and the vehicle by, for example, collapsing, caving-in, deforming, bending, or otherwise distorting to absorb force.

When the animal containment unit 600 is positioned within a vehicle, the wedge dock 604 is sized/configured to be placed in contact with (or in close proximity to) the seat back portion 608 of a vehicle (or front end of a cargo area). As will be described in more detail below, the animal containment 600 can include features for coupling with the wedge dock 604

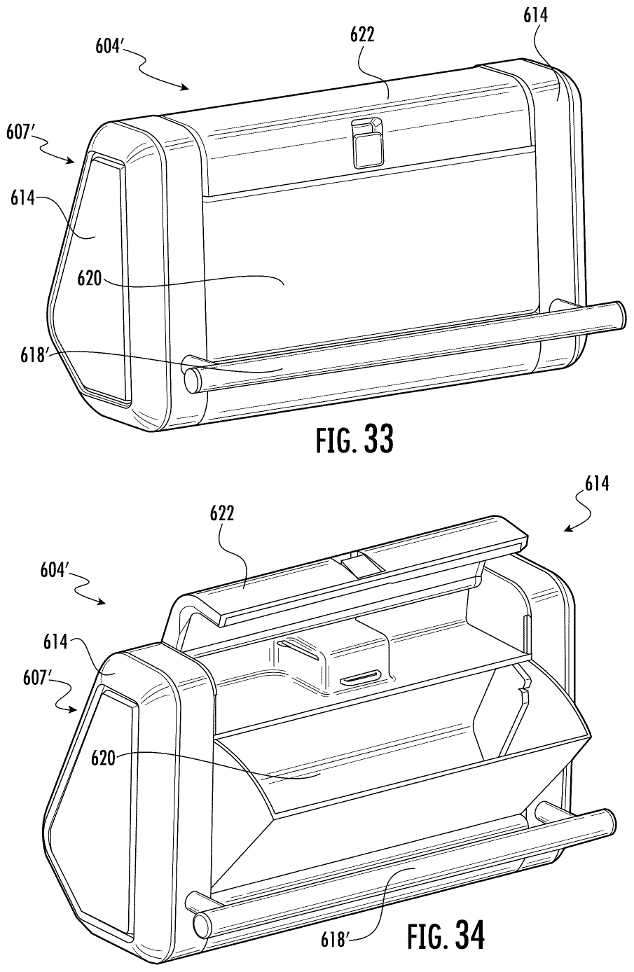

FIGS. 33 and 34 illustrate an alternative wedge dock 604′. The wedge dock 604′ generally includes first and second impact-absorbing ends 614. Between the impact-absorbing ends 614 is a storage compartment 620. A coupling bar 618′ extends between the impact-absorbing ends 614. A lid 622 provides access to the storage compartment 620. A contact surface 607′ is on an opposite side from the coupling bar 618. Although the impact-absorbing ends 614 are configured to absorb a majority of any impact, it will be appreciated that the entire wedge dock 604 can deflect and/or deform to absorb impact energy in extreme cases.

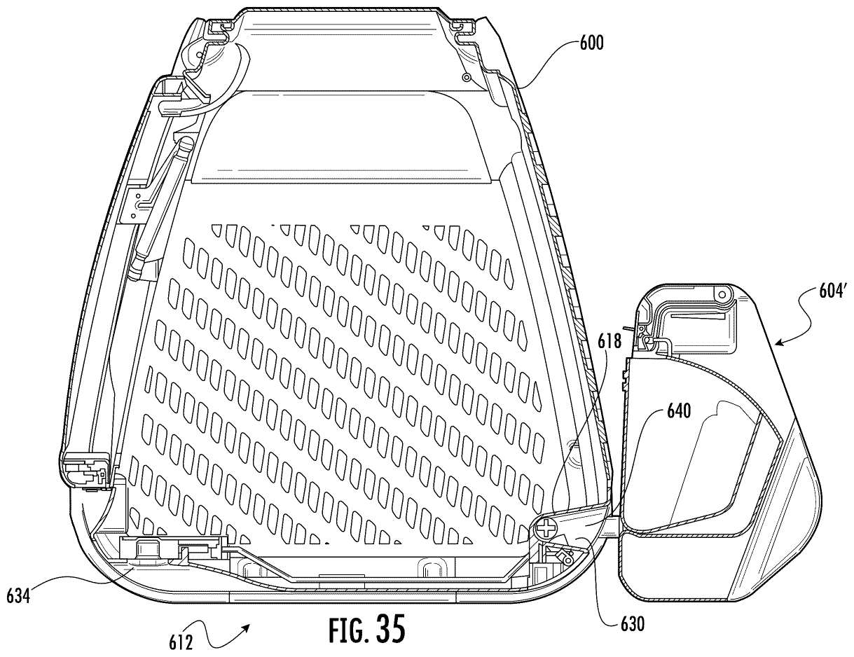

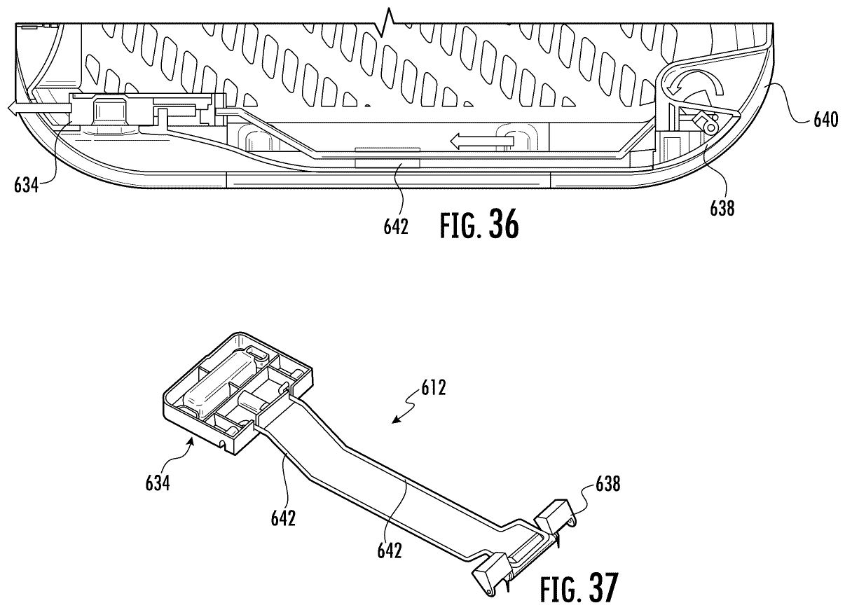

FIG. 35 illustrates the wedge dock 604′ coupled with the animal containment unit 600. FIGS. 36 and 37 illustrate a first exemplary wedge lock mechanism 612 for securing the animal containment unit 600 to the wedge dock 604. The wedge lock mechanism 612 generally comprises a latch mechanism supported by the animal containment unit 600 and configured to releasably engage the coupling bar 618 of the wedge dock 604. The latch mechanism includes a wedge dock actuator 634 located on a rear side of the animal containment unit 600 is coupled to a latch 638 rotatably supported in a recess 640 of the animal containment unit 600 by linkages 642. The latch 638 is generally biased to an engaged position such that a user must actuate the wedge dock actuator 634 to release the animal containment unit 600 from the wedge dock 604.

During installation of the animal containment unit 600 to the wedge dock 604′, the wedge lock mechanism 612 allows a user to couple the animal containment unit 600 to the wedge dock 604′ by forcing the animal containment unit 600 into position such that the latch 638 engages the coupling bar 618 in the recess 640. In general, coupling of the animal containment unit 600 with the wedge dock 604′ does not require actuation of the wedge dock actuator 634 as the latch 638 is designed as a ratchet mechanism that allows the coupling bar 618 to urge the latch 638 clear to fully seat in the recess 640 while restricting withdrawal of the coupling bar 618 from the recess 640 unless the wedge dock actuator 634 is actuated. The wedge dock 604′ is rotatable relative to the animal containment unit 600 such that the contact surface 607 of the wedge dock 604 can be aligned with the seatback 608. During removal of the animal containment unit 600 from the wedge dock 604′, the user can actuate the wedge lock mechanism 612 and simultaneously withdraw the animal containment unit 600 from the wedge dock 604. Actuation of the wedge lock mechanism 612 and removal of the animal containment unit 600 is done in a common direction simplifying the process.

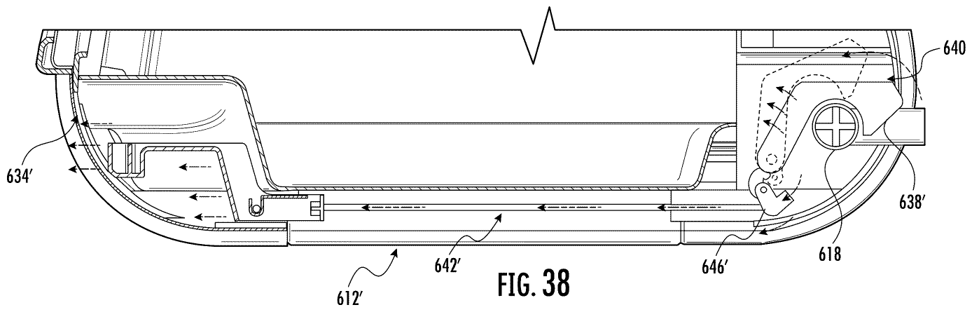

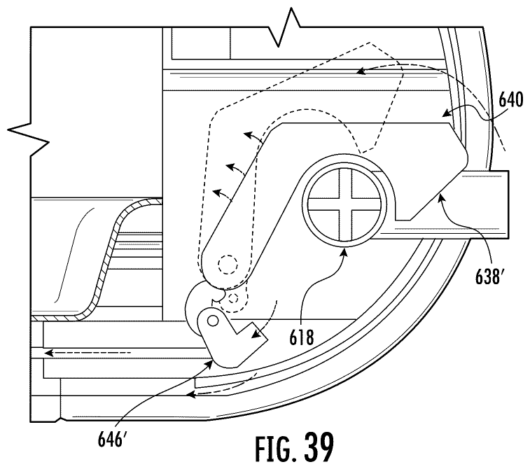

In the embodiment of FIGS. 35-37, the wedge dock actuator 634 acts directly on the latch 638 via linkages 642. FIG. 38 illustrates a second exemplary wedge lock mechanism 612′ for securing the animal containment unit 600 to the wedge dock 604. The wedge lock mechanism 612′ generally comprises a latch mechanism supported by the animal containment unit 600 and configured to releasably engage the coupling bar 618 of the wedge dock 604. The latch mechanism generally includes a wedge dock actuator 634′ located on a rear side of the animal containment unit 600. The wedge dock actuator 634′ is coupled to a latch 638′ rotatably supported in a recess 640 of the animal containment unit 600 by linkages 642′ and cam 646′. The latch 638′ is generally biased to an engaged position such that a user must actuate the wedge dock actuator 634′ to release the animal containment unit 600 from the wedge dock 604′.

During installation of the animal containment unit 600 to the wedge dock 604′, the wedge lock mechanism 612′ allows a user to couple the animal containment unit 600 to the wedge dock 604′ by forcing the animal containment unit 600 into position such that the latch 638′ engages the coupling bar 618 in the recess 640. In general, coupling of the animal containment unit 600 with the wedge dock 604′ does not require actuation of the wedge dock actuator 634′ as the latch 638′ is designed as a ratchet mechanism that allows the coupling bar 618 to urge the latch 638′ clear to fully seat in the recess 640 while restricting withdrawal of the coupling bar 618 from the recess 640 unless the wedge dock actuator 634′ is actuated. During removal of the animal containment unit 600 from the wedge dock 604′, the user can actuate the wedge lock mechanism 612′ and simultaneously withdraw the animal containment unit 600 from the wedge dock 604 in a common direction.

It will be appreciated that the relative positions of the recess 640 and coupling bar 618 can be reversed such that the recess 640 and latch are provided with the wedge dock 604′ and the coupling bar 618 is provided with the animal containment unit 600.

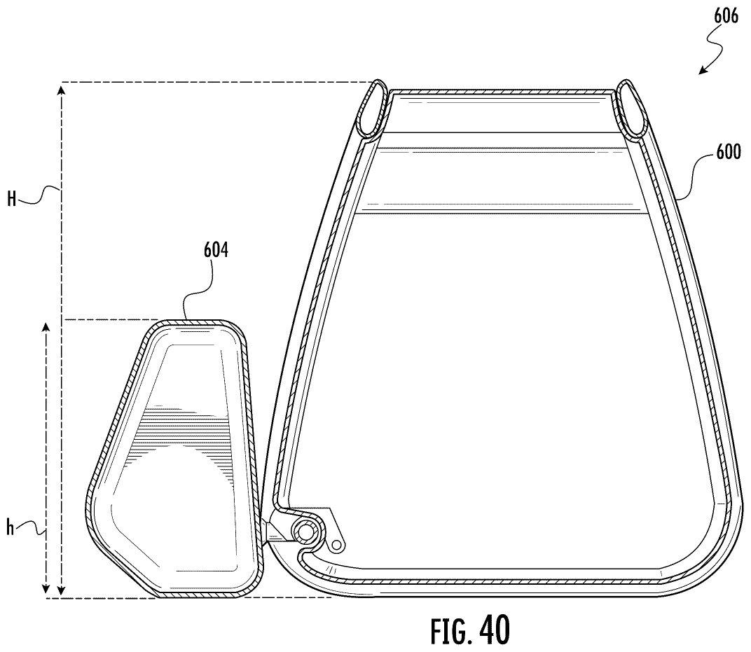

In FIG. 40, it should be appreciated that the impact protection component (e.g., wedge dock 604/604′) can be sized such that a height h of the impact protection component is at least a quarter of a height H of the animal containment unit. In one example, the height h of the impact protection component is at least a half of the height H of the animal containment unit. The heights of the impact protection component and the animal containment unit extend from a bottom of each respective component/device to a top of each respective component/device when the animal crate is positioned within the cargo area of the vehicle.

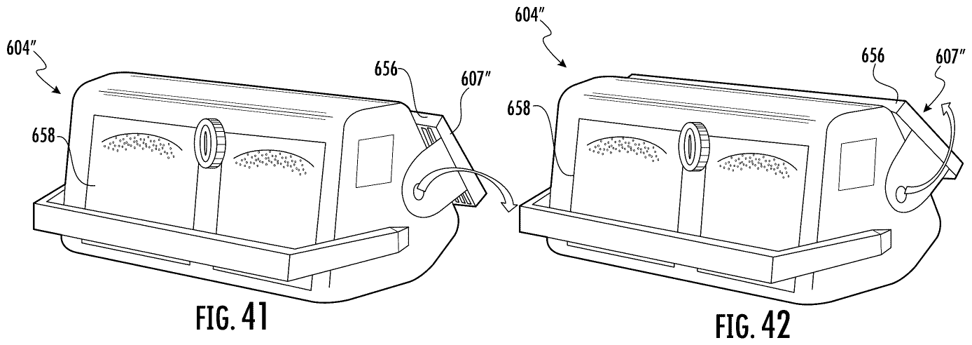

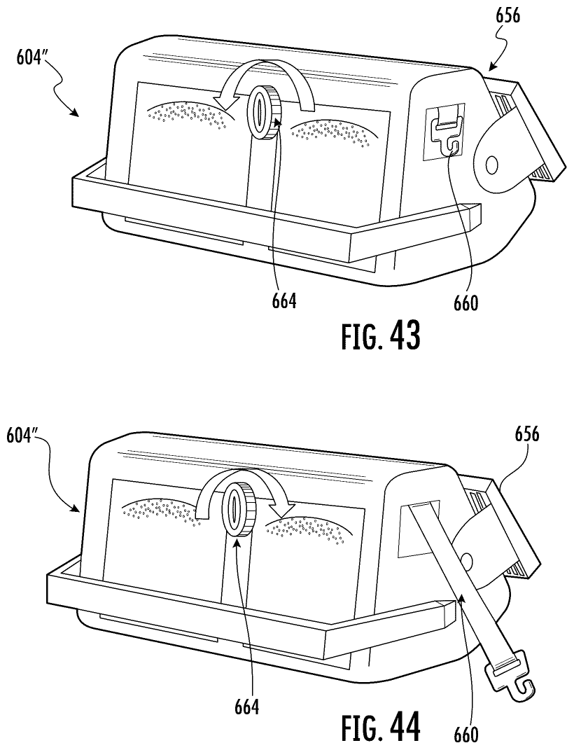

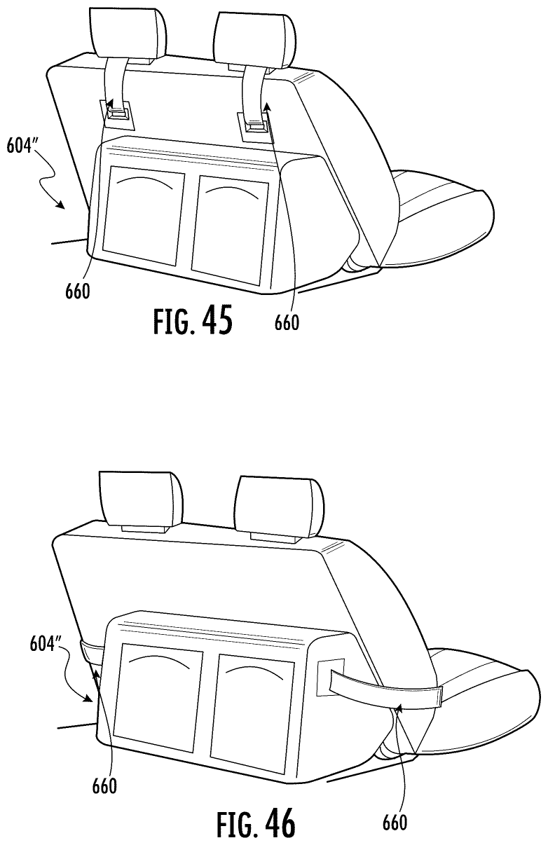

FIGS. 41-50 illustrate various other exemplary impact protection components. In FIGS. 41 and 42, a wedge dock 604″ includes a load leg 656. The load leg 656 includes a contact surface 607″ for contacting a seatback. The load leg 656 is pivotally attached to a body 658 of the wedge dock 604″ such that an angle of the contact surface 607″ can be adjusted to match an angle of the seatback. With additional reference to FIGS. 43 and 44, the wedge dock 604″ includes straps 660 for securing the wedge dock 604″ to anchor points of a vehicle. Tension of the straps 660 can be controlled by a center adjuster 664. Rotating the center adjuster allows the straps 660 or other securing mechanism to be pulled out from wedge dock 604″. As seen in FIGS. 45 and 46, the straps 660 can be routed in a variety of manners to secure the wedge dock 604″ to the vehicle. For example, the wedge dock 604″ can be secured by wrapping a strap 660 connected to the wedge dock 604″ through seat back crease and securing the strap 660 to the seatback, as shown in FIG. 45. Alternatively, the wedge dock 604″ can be secured by wrapping a strap 660 connected to the wedge dock 604″ around the seat back crease and securing the strap 660 to the wedge block 604″ as shown in FIG. 46.

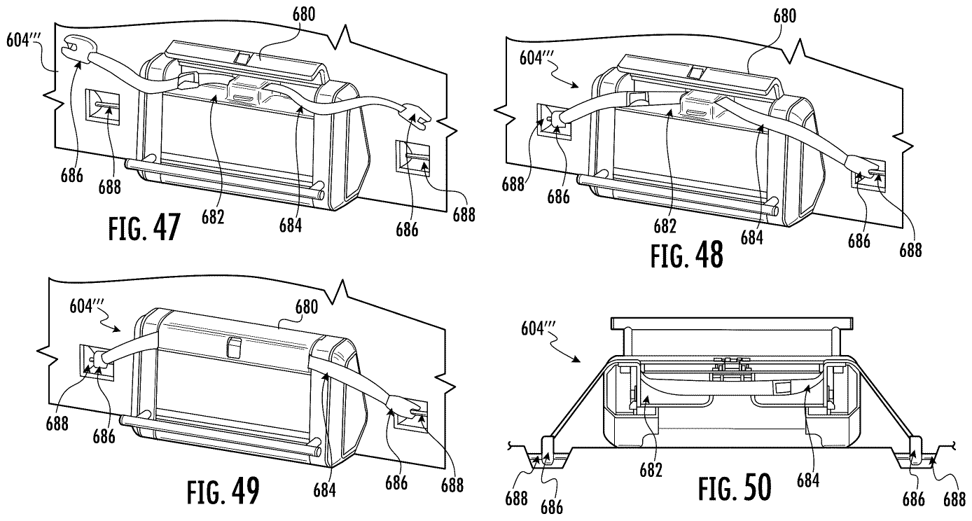

In some embodiments, a wedge dock can include a strap/belt routing and tensioning feature. With reference to FIGS. 47-50, a wedge dock 604′″ includes a lid 680 that can be opened to access a strap channel 682. The strap channel 682 is adapted to receive a strap 684 such that the strap 684 extends between outboard sides of the wedge dock 604″′. The lid 680 and/or strap channel 682 includes structure that applies tension to the strap 684 when closed. During installation of the wedge dock 604″′ to a vehicle, the wedge dock 604′″ is positioned in the vehicle adjacent a seatback, the lid 680 is opened and the strap 684 is routed through the strap channel 682 and connected at each end to respective vehicle anchors as shown in FIG. 47. In the illustrated embodiment, each end of the strap 684 includes latch mechanisms 686 adapted to releasable couple with respective LATCH anchors 688 or other anchor points of a vehicle. The strap 684 can then be manually tightened as shown in FIG. 48. Upon closing the lid 680, the strap 684 is further tensioned as shown in FIGS. 49-50.

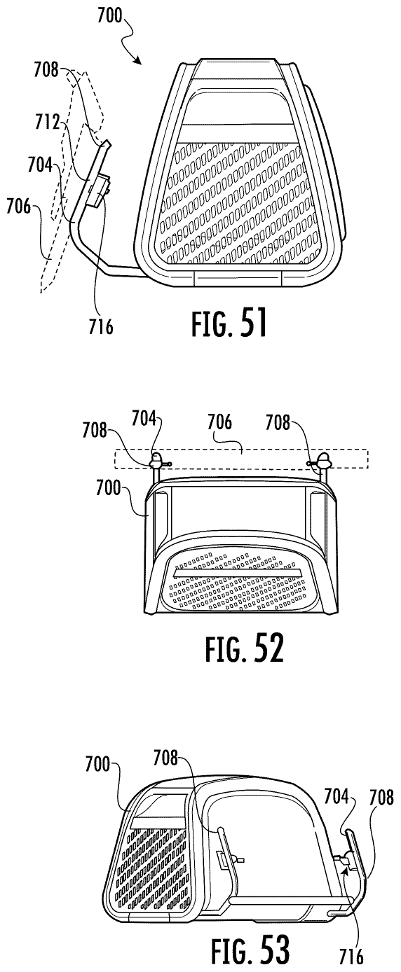

Turning to FIGS. 51-53, another exemplary animal containment unit in accordance with the present disclosure is illustrated and identified generally by reference numeral 700. The animal containment unit 700 includes an impact protection component in the form of an energy-absorbing frame 704. The energy-absorbing frame 700 is secured to the front of the animal containment unit 700 and configured to be interposed between the animal containment unit 700 and a seatback 706 of a vehicle. The energy-absorbing frame 704 includes first and second arms 708. The arms 708 extend outward from a lower portion of the animal containment unit 700 and include a contact surface 712 that is angled back towards the animal containment unit 700. The arms 708 can include retractable straps 716 for securing the animal containment unit 700 to vehicle anchor points. The energy-absorbing frame 704 can be releasably attached to the animal containment unit 700, or can be configured to fold or otherwise collapse when the animal containment unit 700 is removed from a vehicle.,

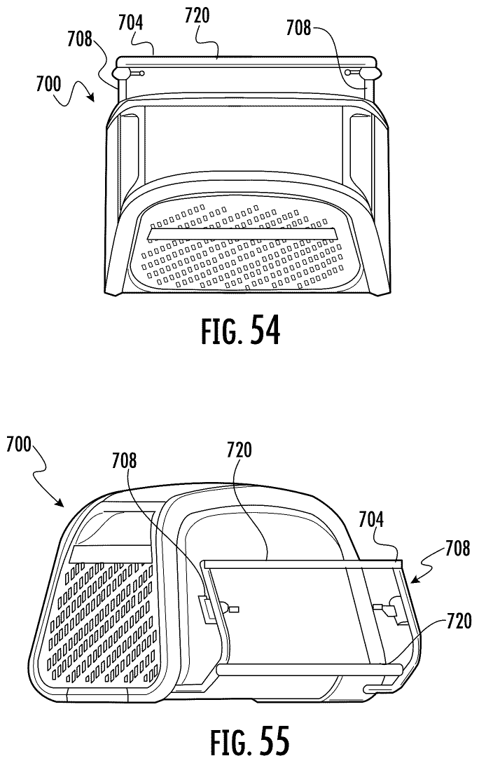

FIGS. 54 and 55 illustrate optional crossbars 720 extending between the arms 708 of the energy-absorbing frame 704. In some embodiments, one or both of the crossbars 720 can be engaged by a latch mechanism of the animal containment unit 700 in a similar manner to the engagement of the animal containment units with the coupling bar of the wedge docks described above.

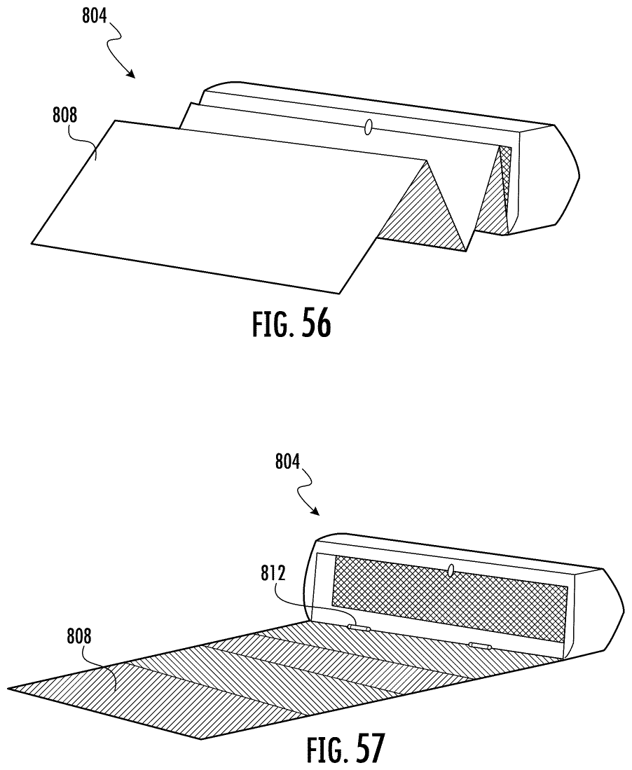

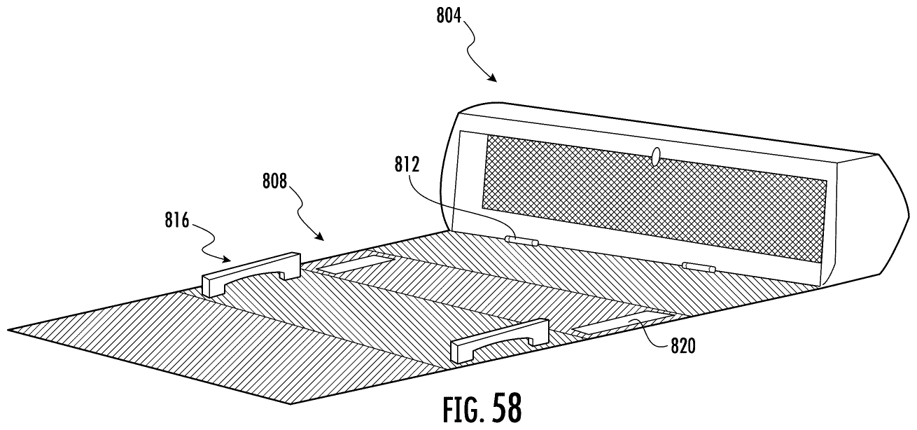

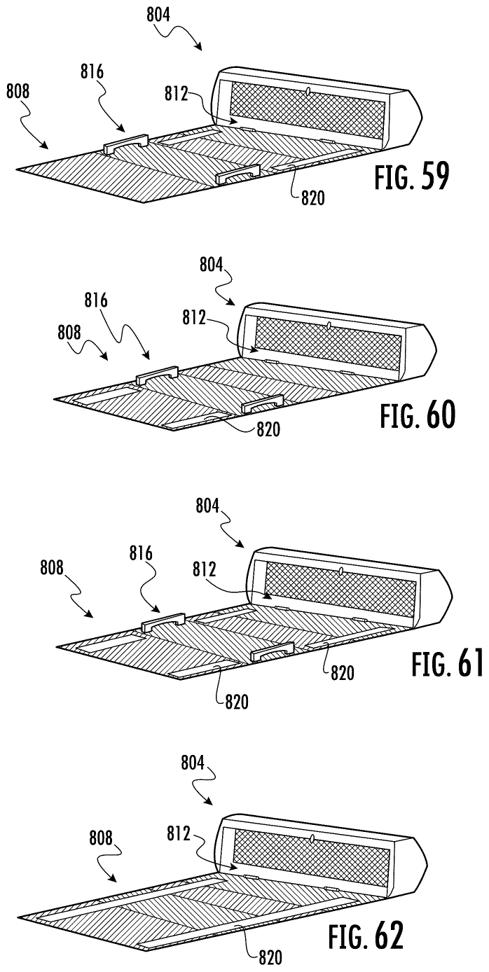

FIGS. 56-62 show a wedge dock 804 for use in connection with an animal containment unit (not shown). The wedge dock 804 includes a mat 808 that provides a support surface for an animal containment unit. The mat 808 is extendable to a use position and retractable to a stored position. In the illustrated example, the mat 808 is connected at one end to the wedge dock 804 via hinges 812 and configured to extend therefrom in accordion fashion. The mat 808 provides a low-friction surface that allows an animal containment unit to slide easily into engagement with the wedge dock 804. In addition, the mat 808 can include one or more retention features for coupling with an animal containment unit. For example, the mat 808 can include rails 816 and/or recesses/grooves 820 which cooperate with portions of an animal containment unit to restrict lateral movement of the animal containment unit. The recesses/grooves 820 can be positioned before the rails 816 (FIG. 59), after the rails 816 (FIG. 60), both before and after the rails 816 (FIG. 61) or continuous (FIG. 62). In some embodiments, the rails 816 can be pivotally connected to the mat 808 and folded to a vertical use position. It will be appreciated that the mat 808 and related features of the present embodiment can be incorporated into any of the previously described wedge docks.

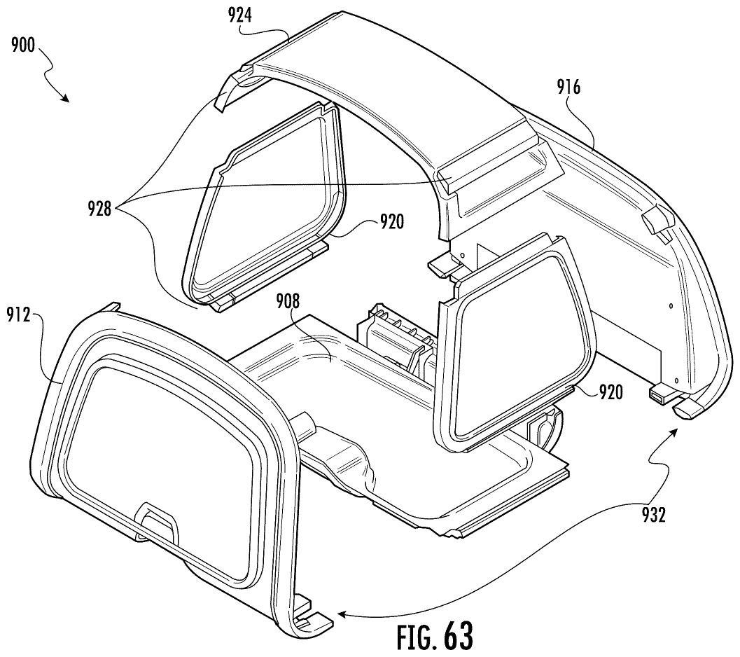

Turning to FIGS. 63-66, another embodiment of an animal containment unit 900 is illustrated. The animal containment unit 900 can be assembled and disassembled making shipping and/or storage of the animal containment unit 900 more convenient. The animal containment unit 900 includes a base panel 908, a rear panel 912, a front panel 916, side panels 920 and a top panel 924. Each of the panels includes interlocking features for securing the panels together to form the assembled animal containment unit 900. The interlocking features can include, for example, press-fit components and/or snap-fit components. In the illustrated example, the side panels 920, top panel 924 and base panel 908 include receivers (e.g., tubes) 928 configured to receive stubs 932 of the front and rear panels 912 and 916. One or more of the panels can be constructed as a one-piece plastic (e.g. polypropylene) part with, for example, an over molded mesh.

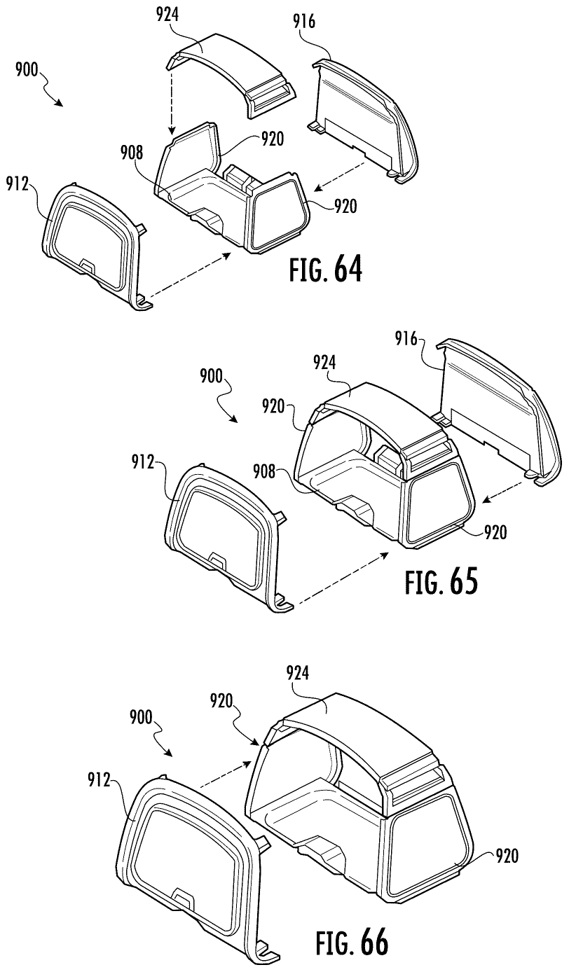

FIGS. 64-66 illustrate an assembly sequence wherein the side panels 920 are secured to the base panel 908 (FIG. 64), the top panel 924 is secured to the side panels (FIG. 65), the front and rear panels 912 and 916 are secured to the base panel 908, side panels 920 and/or top panel 924.

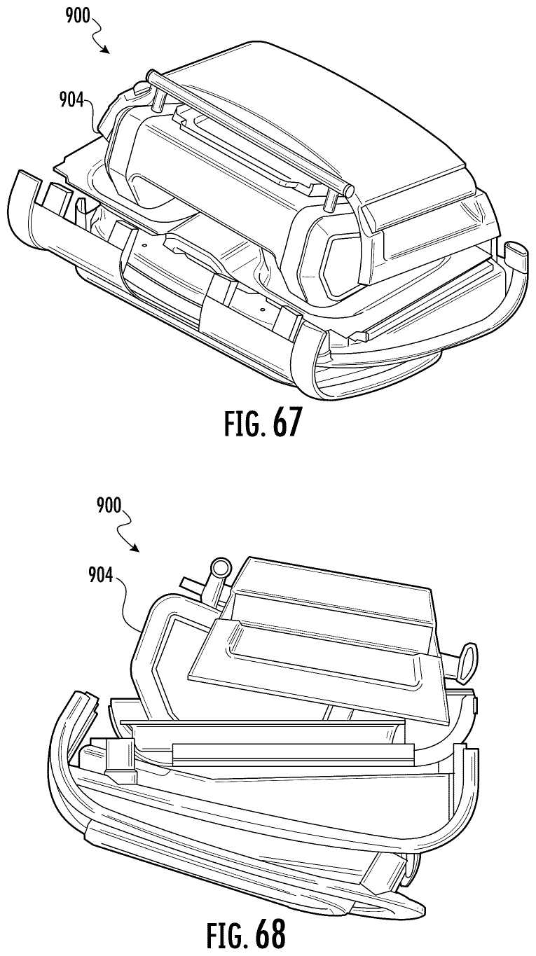

FIGS. 67 and 68 illustrate the animal containment unit 900 in a disassembled condition (e.g., for shipping and/or storage) including a wedge dock 904.

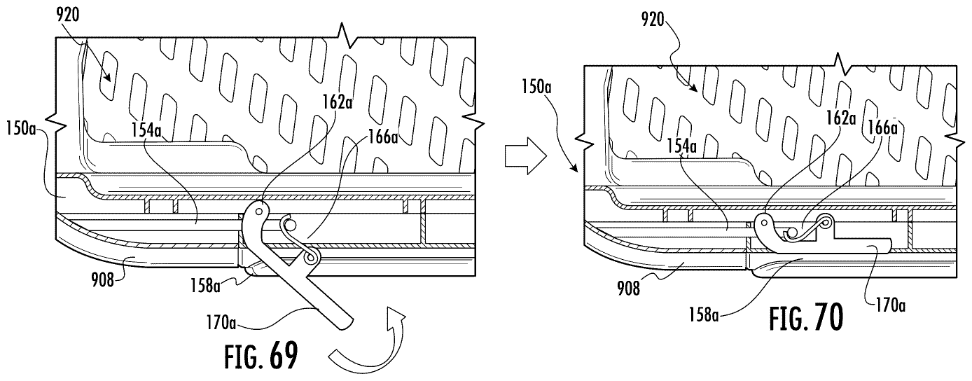

FIGS. 69 and 70 illustrate a latch assembly 150a (e.g., securement mechanism) for releasably securing together two panels of the animal containment unit 900. The two panels in the illustrated example can be, for example, the base panel 908 joining with the side panel(s) 920, the base panel 908 joining with the rear panel 912, the base panel joining with the front panel 916, but it will be appreciated that the latch assembly 150a can be used to connect any adjacent panels including the top panel 924.

The illustrated embodiment of the latch assembly 150a includes a rod 154a associated with the side panel 920 and a latch member 158a associated with the base panel 108a. The latch member 158a is supported for pivoting movement relative to the base panel 908 by pivot 162a. A pivotable latch arm 166a of the latch member 158a is adapted to engage the rod 154a and a handle portion 170a of the latch member 158a is used to rotate the latch member 158a over-center to draw the rod 154a to the right to the position shown in FIG. 70 thereby securing the side panel 920 to the base panel 908.

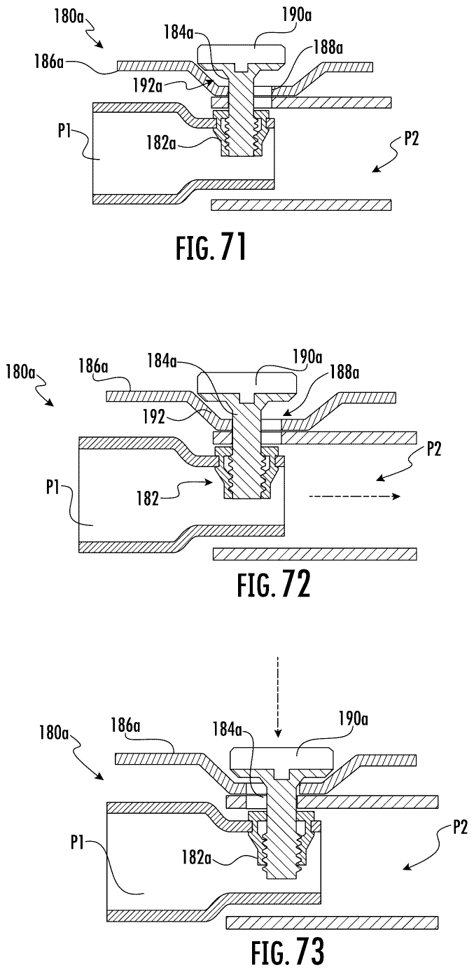

FIGS. 71-73 illustrate a cam bolt assembly 180a for securely interlocking first and second panels P1 and P2 of the animal containment unit 900. It will be appreciated that the first and second panels P1 and P2 can be any of the above-described base 908 and/or panels 912/916/920/924 and/or portions thereof, for example P1 may be the stub 932 and P2 may be the receiver 928. Panel P1 includes a threaded bore 182a for receiving a bolt 184a. Panel P2 includes a cam plate 186a mounted thereto. A slotted hole 188a extends through the panel P2 and the cam plate 186a for passage of the bolt 184a, as shown in FIG. 71. Initially the panels P1 and P2 are aligned as shown in FIG. 71 and the bolt 184a is passed through the slotted hole 188a and threaded into the threaded bore 182a. Upon tightening of the bolt 184a, a head 190a of the bolt 184a impinges a cam surface 192a of the cam plate 186a which tends to force the bolt 184a and, consequently, the panel P1 to the right as shown in FIG. 72 to the position shown in FIG. 73 thereby drawing panels P1 and P2 together to a secured final position.

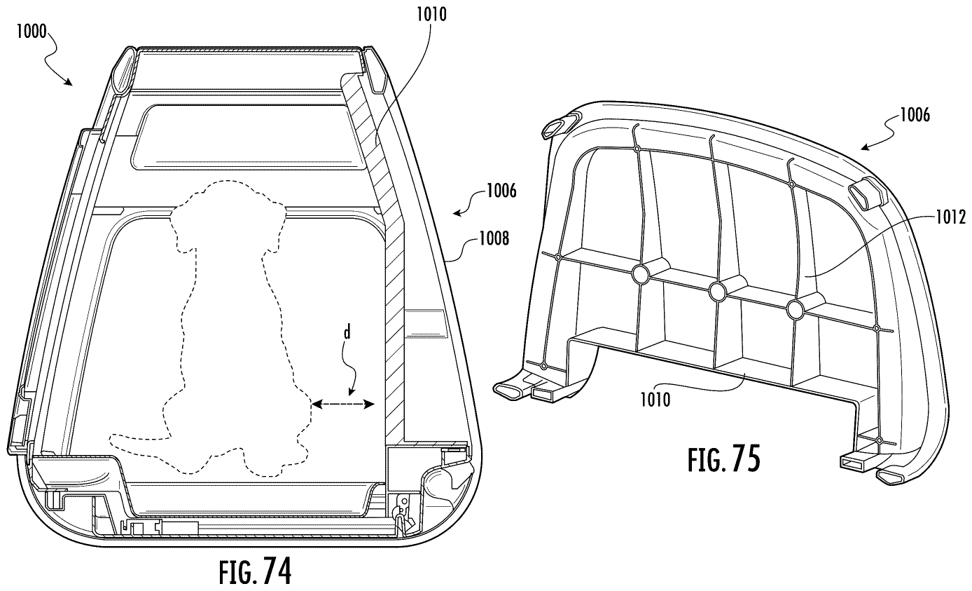

FIGS. 74 and 75 illustrate another exemplary animal containment unit 1000. The animal containment unit 1000 is similar to the animal containment units described above but the front panel 1006 includes both an exterior panel 1008 and an impact panel 1010. The impact panel 1010 reduces the spacing d between an animal in the animal containment unit 1000 and the front of the animal containment unit 1000 to reduce a potential impact force on the animal in the event of a vehicle collision. The impact panel 1010 can include voids/ribs or other intervening structure 1012 filled with an impact-absorbing material such as foam, for example. The impact panel 1010 can be a separate panel or can be part of a front panel of an animal containment unit. The front panel 1006 may provide additional structural reinforcement of the containment unit 1000, and the panel subassembly may provide improved crash performance by dissipating impact energy or cushioning animal impact. The panel subassembly of the front panel 1006 may also have space between the inner impact panel 1010 and the exterior panel 1008, and embodiments with such space may include one or more intervening structure(s) 1012 such as ribs, voids, foam, or the like. In some embodiments, one or more of the inner impact panel 1010 and intervening structure can be configured to flex or otherwise deform in a resilient or non-resilient manner to absorb impact energy. In a general sense, the front panel 1006 of such embodiments may be considered a “crash panel” that is distinct from the other panel(s) of the containment unit 1000 by being thicker, stronger, and/or more cushioned than the other panels. Moreover, the crash panel of such embodiments, contrasted from the other panel(s) of the containment unit 1000, may have additional features that improve crash performance and protection of the animal within the unit.

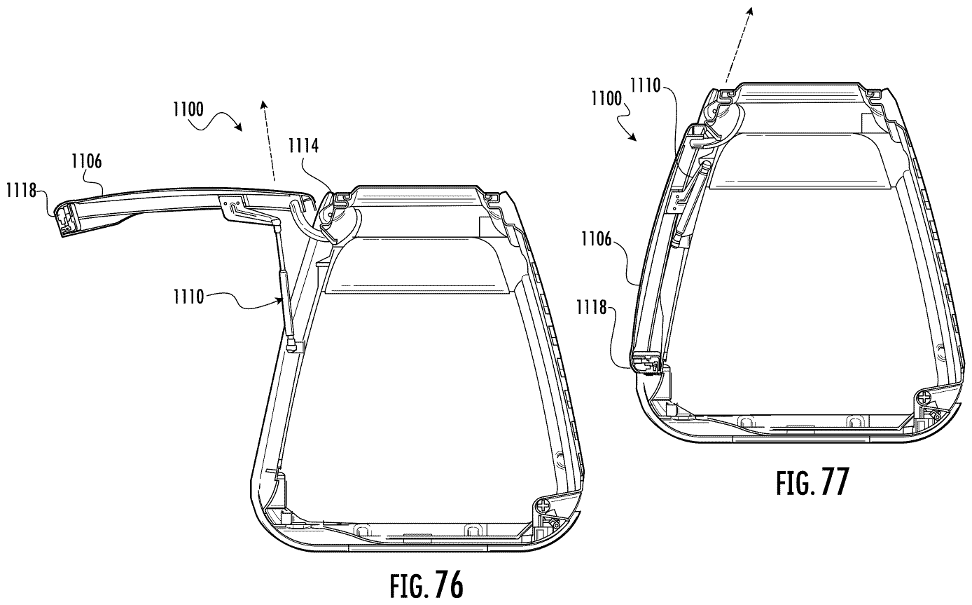

FIGS. 76 and 77 illustrate an exemplary animal containment unit 1100 with a door 1106 and a gas strut 1110. The door 1106 is secured to the body of the animal containment unit with a hinge 1114 such that the door 1106 opens upwardly allowing access to an interior of the animal containment unit. A door latch 1118 is configured to selectively secure the door 1106 in a closed state. The gas strut 1110 is configured to maintain the door 1106 in an open state and/or assist in moving the door from a closed state to an open state. The gas strut 1110 can be mounted such that when the door 1106 is closed, the gas strut 1110 rotates over center and applies a force to the door 1106 that tends to maintain the door 1106 in a closed state. In this case, the door 1106 remains in a generally closed state until a user lifts the door 1106 at least partially open.

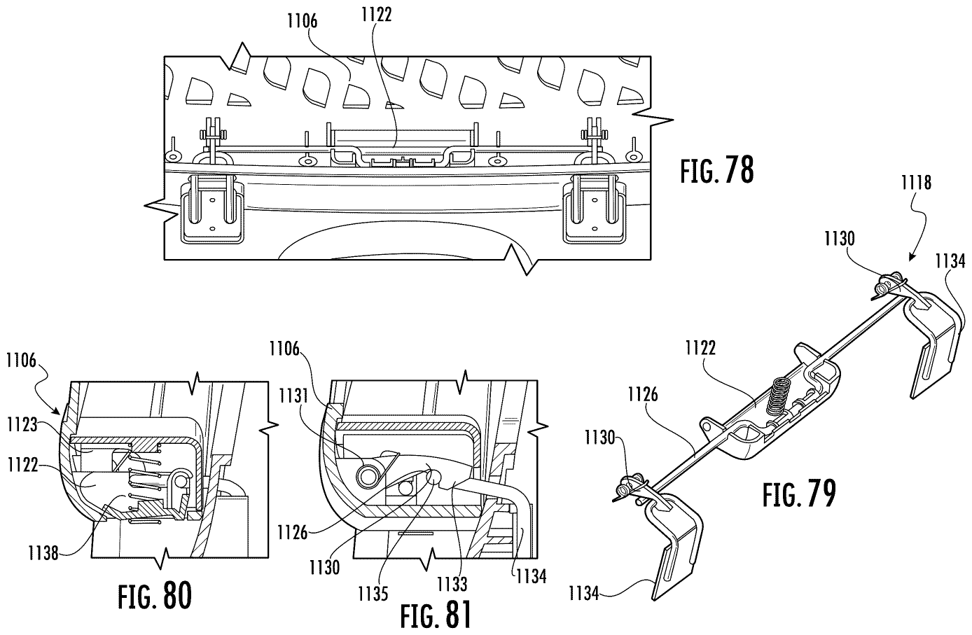

FIGS. 78-81 illustrate the door latch 1118 in more detail. The door latch 1118 generally includes a handle 1122 coupled to a linkage rod 1126 which is rotatably supported in the door 1106 and coupled to first and second latch members 1130. The first and second latch members 1130 are configured to selectively engage respective strikers 1134 of the animal containment unit 1100 to maintain the door 1106 in a closed state. Actuation of the handle 1122, such as by lifting up on the handle 1122, rotates the latch members 1130 out of engagement with the strikers 1134 allowing the door 1106 to be opened.

In some embodiments of the door latch 1118, a first biasing component 1138 (e.g., a compression spring as shown) may be provided to bias the handle 1122 toward its non-actuated position such that the latch 1118 is biased to maintain the door 1106 in a closed state. Similarly, a second biasing component 1131 (e.g., a torsion spring as shown) may be provided with one or more of the latch members 1130 to bias the latch member(s) to the engaged position with the corresponding striker(s) 1134. Each of the latch members 1130 may include an angled surface 1133 and a catch surface 1135, whereby a closing motion of the door 1106 automatically causes the door latch 1118 to engage the striker 1134 and thereby maintain a closed door position. As shown in FIGS. 79 and 81, the angled surface 1133 is positioned to contact the striker 1134 as the door 1106 moves from the open position to the closed position, causing the latch member 1130 to temporarily rotate upwardly as it moves across the striker toward the closed position. Subsequently, the bias against the latch member 1130 causes it to rotate back downward for the catch surface 1135 to engage and hold the striker 1134.

A latch housing 1133 may be affixed to the door 1106 and at least partially shroud components of the door latch 1118. In some embodiments, the latch housing 1133 supports the biasing component 1128 and enshrouds the handle 1122. In the illustrated embodiment, the latch housing 1133 extends along the door 1106 to enshroud the latch members 1130.

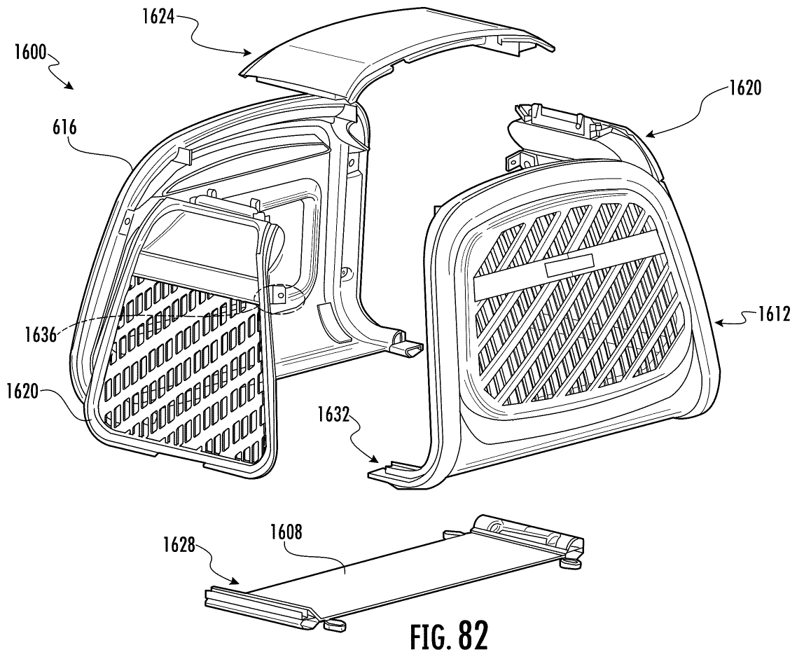

FIG. 82 shows another exemplary embodiment of an animal containment unit 1600. The animal containment unit 1600 can be assembled and disassembled making shipping and/or storage of the animal containment unit 1600 more convenient. The animal containment unit 1600 includes a base panel 1608, a rear panel 1612, a front panel 1616, side panels 1620 and a top panel 1624. Each of the panels includes interlocking and/or mating features for securing the panels together to form the assembled animal containment unit 1600. The interlocking and/or mating features can include, for example, press-fit components and/or snap-fit components. In the illustrated example, the side panels 1620, top panel 1624 and/or base panel 1608 include tubes 1628 configured to receive stubs 1632 of the rear and front panels 1612 and 1616. The side panels 1620 further include bolt holes 1636 for receiving bolts/screws for further securing the rear panel 1612 and front panel 1616 to the side panels 1620.

To assemble the animal containment unit 1600, a user will first assemble the side panels 1620 to the base panel 1608. Next, the top panel 1624 is assembled to the side walls 1620. Finally, the rear panel 1612 and front panel 1616 are positioned and bolted to the side panels 1620.

Although the disclosure may illustrate different embodiments, it is contemplated that aspects of individual embodiments may be combined or omitted. Therefore, the disclosure and claims are not intended to be limited to the illustrated embodiments.

Embodiments of the disclosed device may include slots at, for example, the top corners for tie-down straps. The top of the containment unit may further include one or more handles. The animal containment unit can comprise a material that is durable and has the strength of heavy-duty kennels with some of the flexibility & aesthetics of soft-sided crates and animal beds.

An adaptor can be provided that mounts to the docking stations in the same way as a larger crate and positively retains smaller crate. The adaptor can be for a specific rear cargo crate having the same features of this disclosure, or may be for certain other dog crates without these features, or may be universal for any crate. The adaptor may mimic LATCH anchors or seatbelt straps for retaining the crate.

It will be appreciated by those skilled in the art that changes may be made to the embodiments described above without departing from the inventive concept thereof. It should further be appreciated that structural features and methods associated with one of the embodiments can be incorporated into other embodiments. It is understood, therefore, that this invention is not limited to the particular embodiment disclosed, but rather modifications are also covered within the scope of the present invention as defined by the appended claims.

While certain examples have been described, these examples are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The words “inward,” “outward,” “upper,” and “lower” refer to directions toward or away from, respectively, the geometric center of the component.

It will be understood that reference herein to “a” or “one” to describe a feature such as a component or step does not foreclose additional features or multiples of the feature. For instance, reference to a device having, comprising, including, or defining “one” of a feature does not preclude the device from having, comprising, including, or defining more than one of the feature, as long as the device has, comprises, includes, or defines at least one of the feature. Similarly, reference herein to “one of” a plurality of features does not foreclose the invention from including two or more of the features. For instance, reference to a device having, comprising, including, or defining “one of a protrusion and a recess” does not foreclose the device from having both the protrusion and the recess.

1. A system for containing an animal in a vehicle, comprising:
a docking station configured to be received in a cargo area of a vehicle; and
an animal containment unit selectively mountable to the docking station.

2. The system of claim 1, wherein the docking station includes at least one anchor point for securing the docking station to at least one anchor point of the vehicle.

3. The system of claim 1, wherein at least one of the docking station or the animal containment unit includes at least one rigid support structure for engaging a non-horizontal surface of the vehicle, the at least one rigid support structure configured to restrict relative movement of the docking station or the animal containment unit relative to the non-horizontal surface.

4. The system of claim 3, wherein the docking station includes a plurality of rigid support structures, each rigid support structure adapted to engage a different non-horizontal surface of the vehicle.

5. The system of claim 4, wherein at least two of the plurality of rigid support structures extend from opposite sides of the docking station.

6. The system of claim 3, wherein the at least one rigid support structure is movable between a stowed position and a deployed position.

7. The system of claim 3, wherein the at least one rigid support structure is adjustable in length.

8. The system of claim 1, wherein the docking station includes a latch configured to selectively secure the animal containment unit to the docking station.

9. The system of claim 1, wherein the animal containment unit further comprises a rotatable and extendable handle.

10. The system of claim 9, wherein the handle is rotatable to a horizontal orientation and extendable to engage a non-horizontal surface of the vehicle to secure the animal containment unit when the animal containment unit is attached to the docking station.

11. The system of claim 2, wherein the docking station includes a base having brackets fixed to side surfaces of the base, the brackets comprising the at least one anchor point and further including tensionable flexible members extending from the brackets for attachment to the at least one anchor point of the vehicle.

12. The system of claim 11, wherein the tensionable flexible members include tethers.

13. The system of claim 11, wherein the docking station includes a ramp extending from a rear portion of the base.

14. The system of claim 13, wherein the ramp is telescoping and includes extensions storable within a cavity in the base.

15. The system of claim 3, wherein the docking station includes a base, and wherein the at least one rigid support structure is U-shaped including first members slidable within side surfaces of the base so that the first members can be slid into a cavity in the base or slid out from the cavity to adjust a length of the at least one rigid support structure.

16. The system of claim 15, wherein the rigid support structure include a second member configured to engage an interior surface of the vehicle.

17. The system of claim 3, wherein the docking station includes a base, and wherein the docking station further includes a vertical rigid support member having first members extending from side surfaces of the base and curving vertically and a second member including sliding members slidable within the first members to adjust a length of the vertical rigid support member.

18. The system of claim 1, wherein the animal containment unit includes wheels on a bottom surface.

19. The system of claim 1, wherein the docking station includes two spaced-apart rails adapted to support the animal containment unit.

20. The system of claim 19, wherein each rail includes a protrusion adapted to be received in a corresponding recess of the animal containment unit to secure the animal containment unit to the docking station.

21. The system of claim 20, wherein the protrusion includes an L bracket, and wherein the corresponding recess includes a slot.

22. The system of claim 19, wherein each rail includes an end face having at least one of a recess or protrusion and wherein the animal containment unit includes a corresponding mating recess or protrusion adapted to secure the animal containment unit to the docking station.

23. The system of claim 1, wherein the docking station includes a load leg configured to engage a seatback of a vehicle.

24. The system of claim 23, wherein the load leg includes an adjustable engagement member, the adjustable engagement member being adjustable to match an angle of the seatback of a vehicle.

25. The system of claim 24, wherein the adjustable engagement member is biased towards a vertical orientation.

26. The system of claim 1, further comprising an organizer mountable to the docking station.

27-83. (canceled)
